(19) United States
(12) Patent Application Publication
(10) Pub. No.: US 2007/0027760 A1
(43) Pub. Date: Feb. 1, 2007

(54) System and method for creating and providing a user interface for displaying advertiser defined groups of advertisement campaign information

(76) Inventors: Robert J. Collins, Carlsbad, CA (US); Paul Joseph Apodaca, Carlsbad, CA (US); Adam J. Wand, Carlsbad, CA (US); Claude Jones III, San Marcos, CA (US)

Correspondence Address: BRINKS HOFER GILSON & LIONE, P.O. BOX 10395, CHICAGO, IL, 60610, US

(21) Appl. No.: 11/413,514

(22) Filed: Apr. 28, 2006

Related U.S. Application Data
(60) Provisional application No. 60/703,904, filed on Jul. 29, 2005.

(51) Int. Cl. G06Q 30/00

(52) U.S. Cl. 705/14

(57) ABSTRACT

A system and method for creating and providing a user interface for displaying advertiser defined groups of advertisement campaign information is disclosed. Generally, advertisement campaign information is organized into one more ad groups. An ad group typically includes advertisements and parameters for advertisements that are to be handled by an advertisement campaign management system in a similar manner. At least a portion of the advertisement campaign information is then displayed based at least in part on at least one of the one or more ad groups. In one embodiment, the portion of the advertisement campaign information is displayed in a graphical user interface running on an internet browser. In another embodiment, the portion of the advertisement campaign information is displayed in a stand-alone application running on a user device.

### RELATED APPLICATIONS

The present patent document claims the benefit of the filing date under 35 U.S.C. §119(e) of Provisional U.S. Patent Application Ser. No. 60/703,904, filed Jul. 29, 2005, the entirety of which is hereby incorporated herein by reference.

### BACKGROUND

Users who advertise with an online advertisement service provider such as Yahoo! Search Marketing typically manage various types of online advertising through the use of a spreadsheet upload/download facility, a user interface, or an application program interface (“API”) to an advertisement management system of the advertisement service provider. Traditionally, users have been able to perform operations with the user interface or API such as adding, editing, or removing advertisements from their account, or modifying various parameters associated with advertisements such as budget parameters or performance parameters.

Current user interfaces and APIs to online advertisement service providers typically allow users to modify parameters associated with individual advertisements or to modify parameters associated with advertisements as grouped by the advertisement service provider. As online advertising has increased in popularity, users may have thousands of advertisements that need to be managed at any given time. The amount of information available on the internet presents many technical problems to an online advertiser seeking to manage data stored in a database when the data defines online advertisements and data processing results. Therefore, it is desirable to provide a user interface and an API to an advertisement campaign management system that allows users to flexibly, dynamically, and efficiently manage large groups of advertisements as defined by the advertiser rather than the advertisement service provider.

### BRIEF DESCRIPTION OF THE DRAWINGS

FIG. 1 illustrates one embodiment of a pod of an advertisement campaign management system;

FIG. 2 is a block diagram of one embodiment of a model for the maintenance of advertisement campaign information according to the advertisement campaign management system of FIG. 1;

FIGS. 3-31 are examples of different embodiments of graphical user interfaces (“GUIs”) of the campaign management system of FIG. 1, that provide a user the ability to display, manage, optimize, or view and customize reports on, advertisement campaign information;

FIG. 32 is a block diagram of one embodiment of a system for facilitating display of advertisement campaign information;

FIG. 33 is a flow diagram of one embodiment of a method for facilitating display of advertisement campaign information;

FIG. 34 is block diagram of one embodiment of a system for managing advertisement campaign information;

FIG. 35 is a flow diagram of one embodiment of a method for managing advertisement campaign information;

FIG. 36 is a flow diagram of another embodiment of a method for managing advertisement campaign information;

FIG. 37 is a flow diagram of another embodiment of a method for managing advertisement campaign information;

FIG. 38 a block diagram of one embodiment of a system for optimizing advertisement campaign information;

FIG. 39 is a flow diagram of one embodiment of a method for optimizing advertisement campaign information;

FIG. 40 is a flow diagram of another embodiment of a method for optimizing advertisement campaign information;

FIG. 41 is a flow diagram of another embodiment of a method for optimizing advertisement campaign information;

FIG. 42 is a block diagram of one embodiment of a system for reporting advertisement campaign information;

FIG. 43 is a flow diagram of one embodiment of a method for reporting advertisement campaign information;

FIG. 44 is a flow diagram of another embodiment of a method for reporting advertisement campaign information; and

FIG. 45 is a block diagram of one embodiment of a system for interacting with an application program interface (“API”) of an advertisement campaign management system.

### DETAILED DESCRIPTION OF THE DRAWINGS

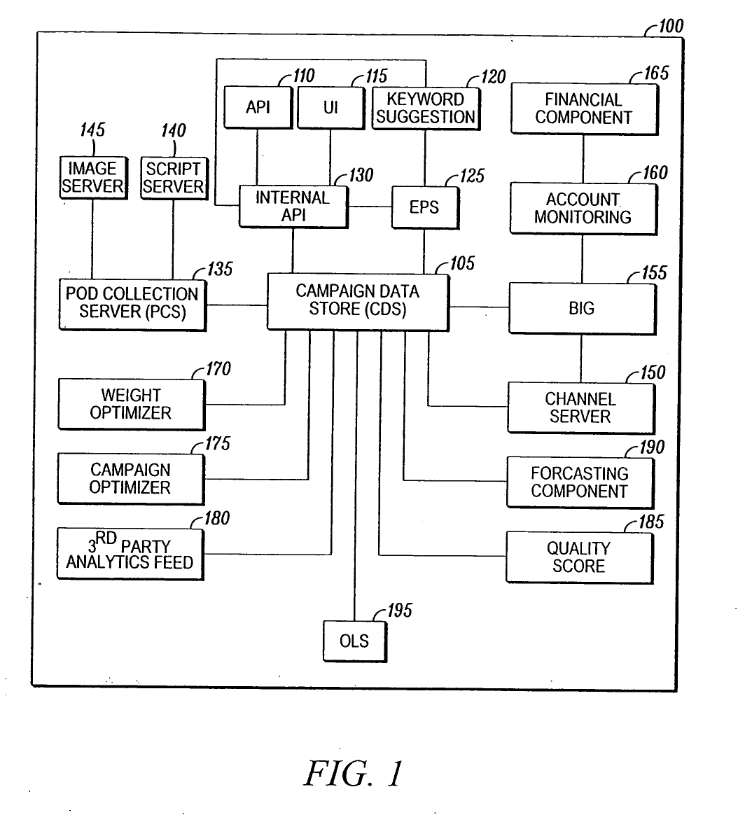

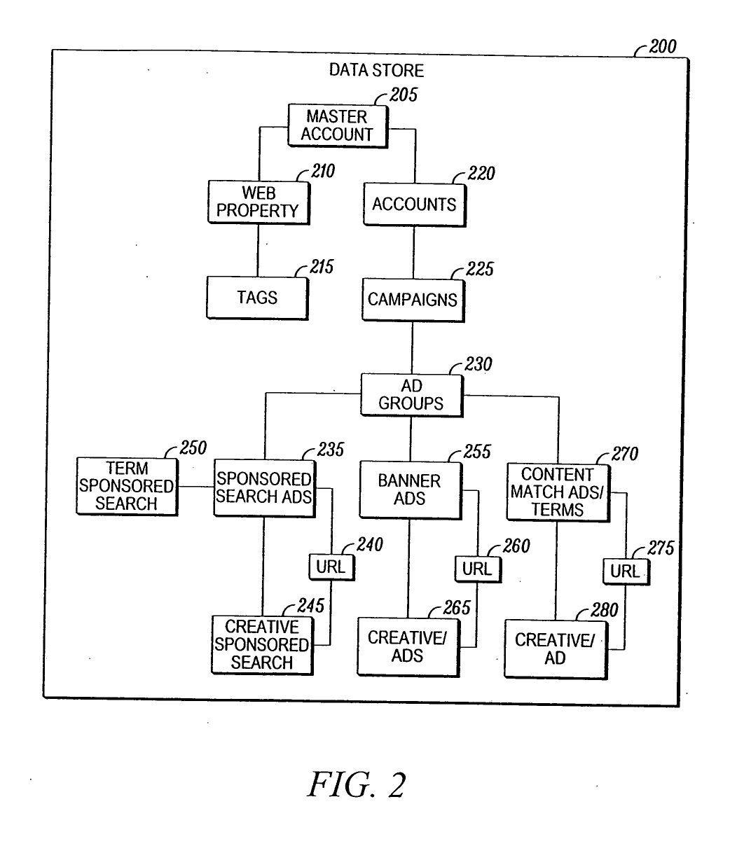

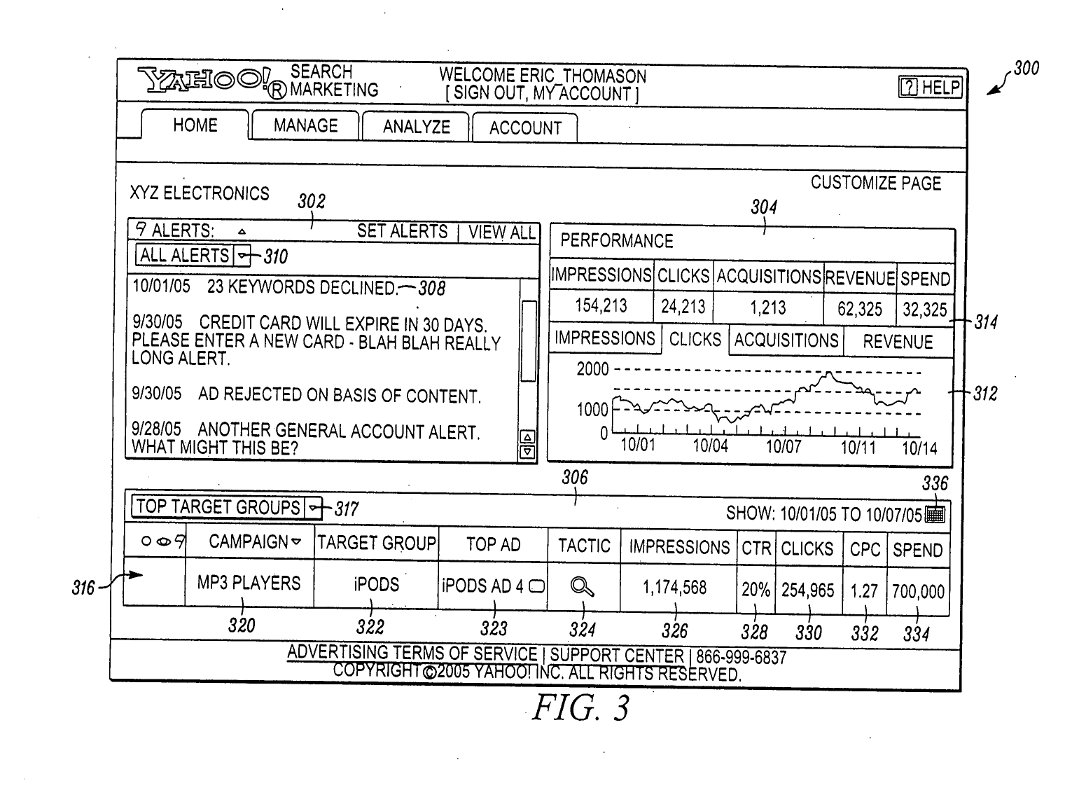

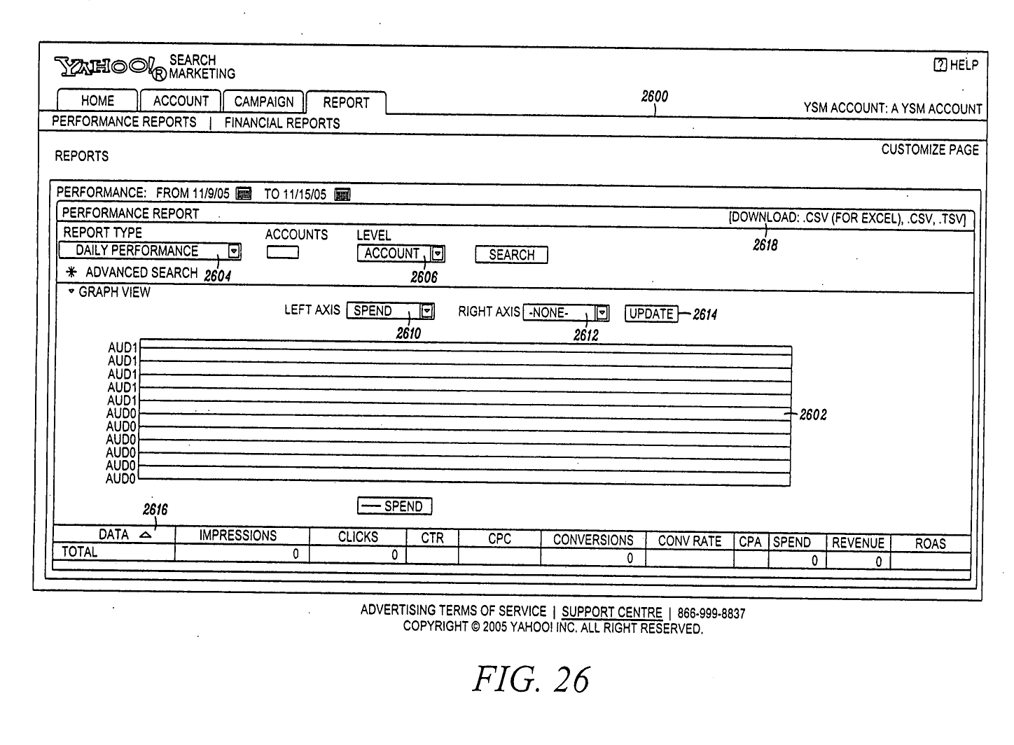

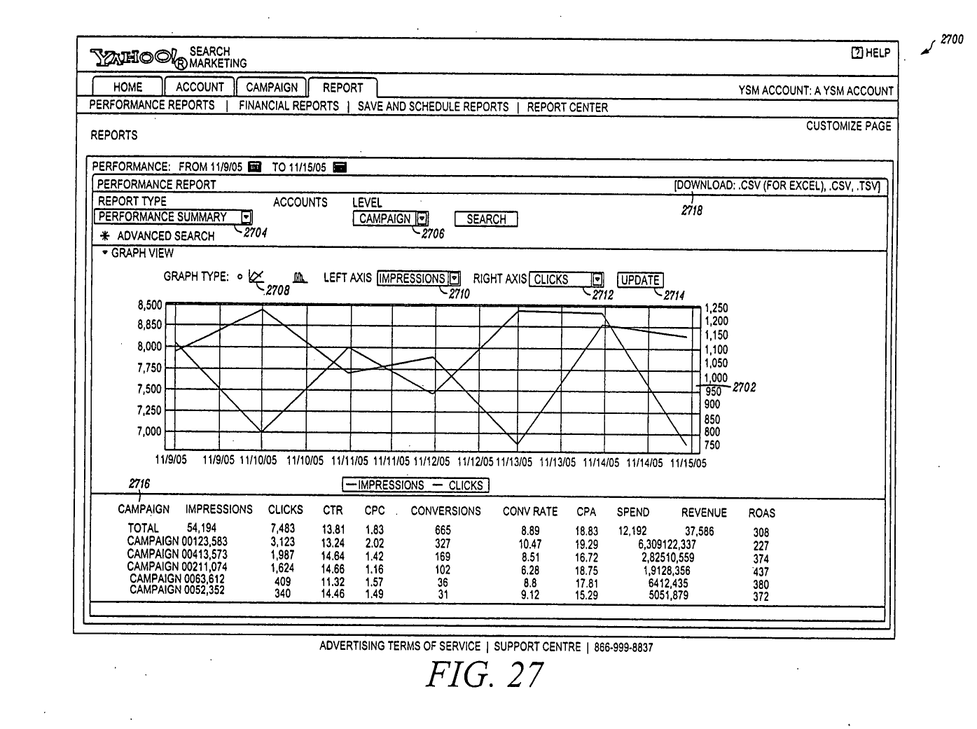

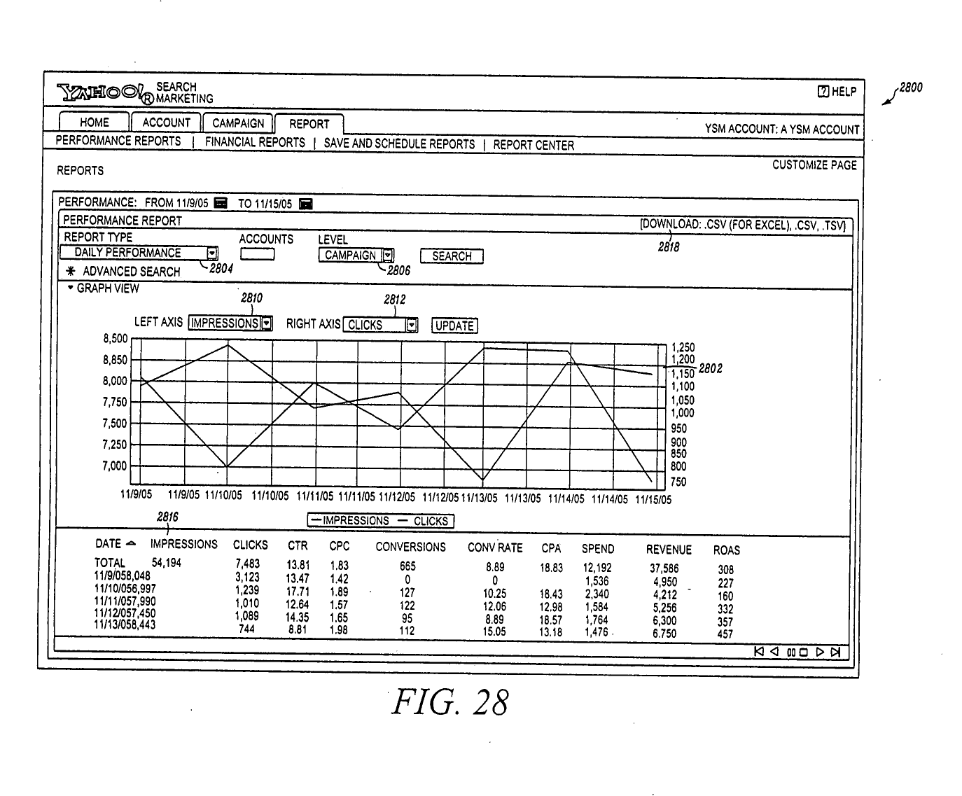

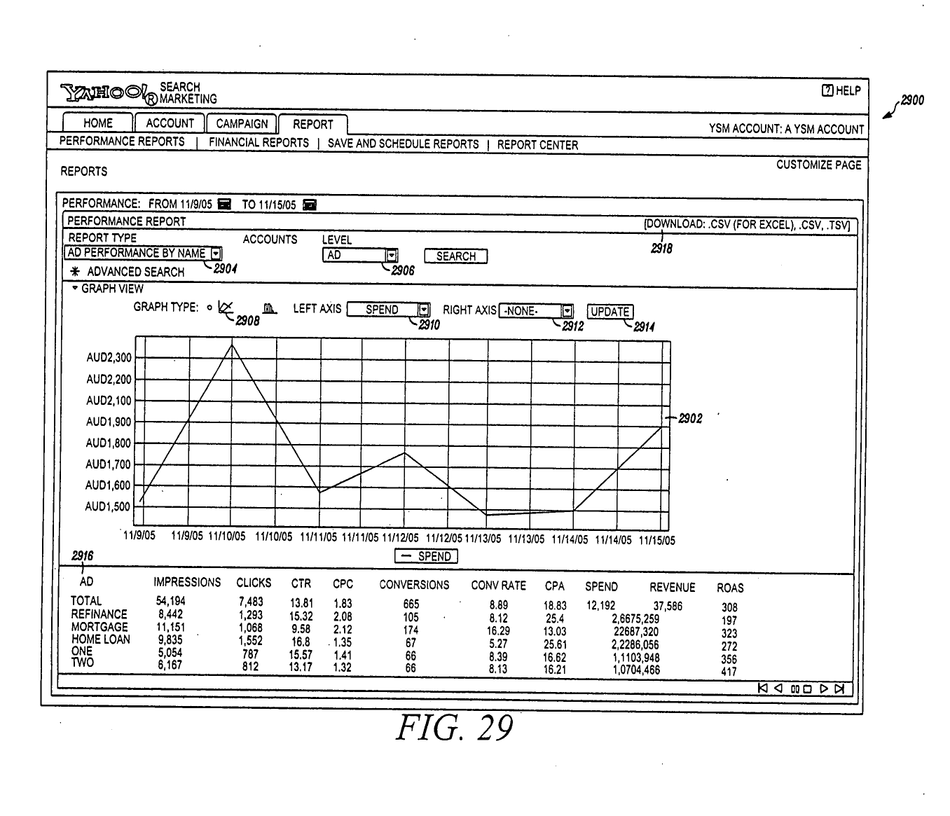

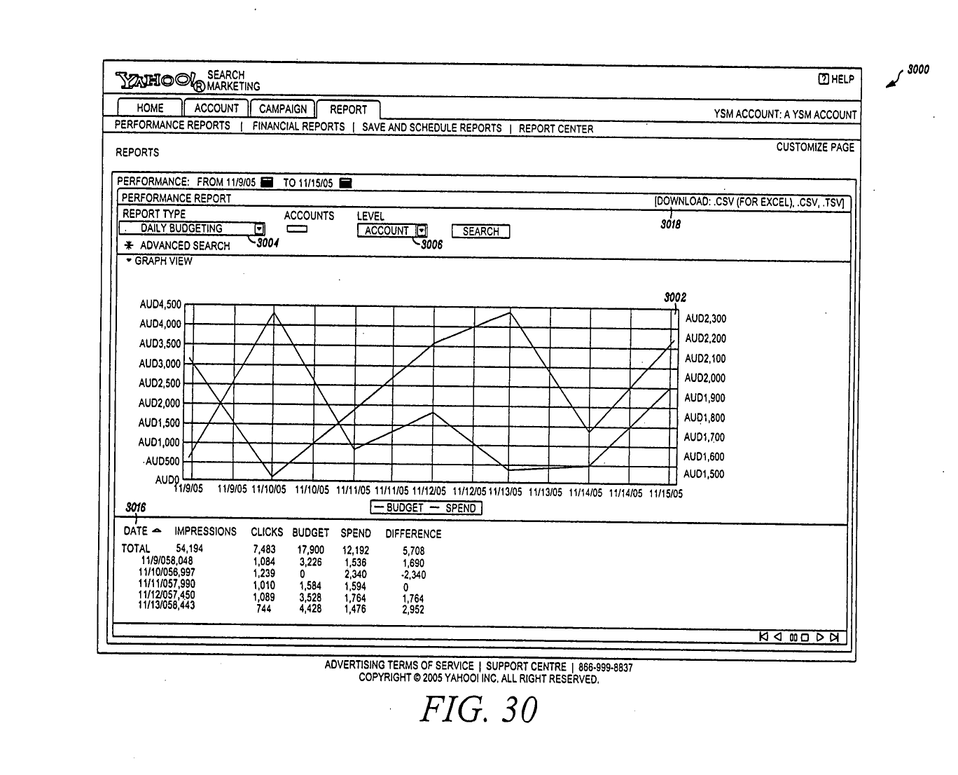

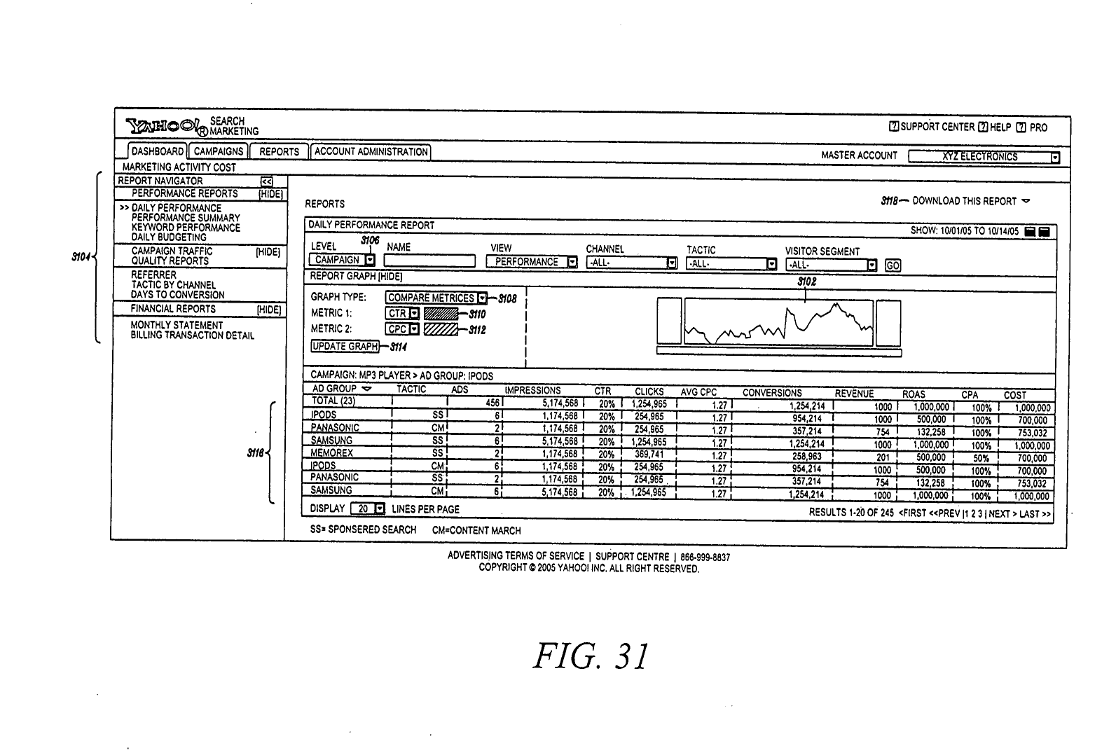

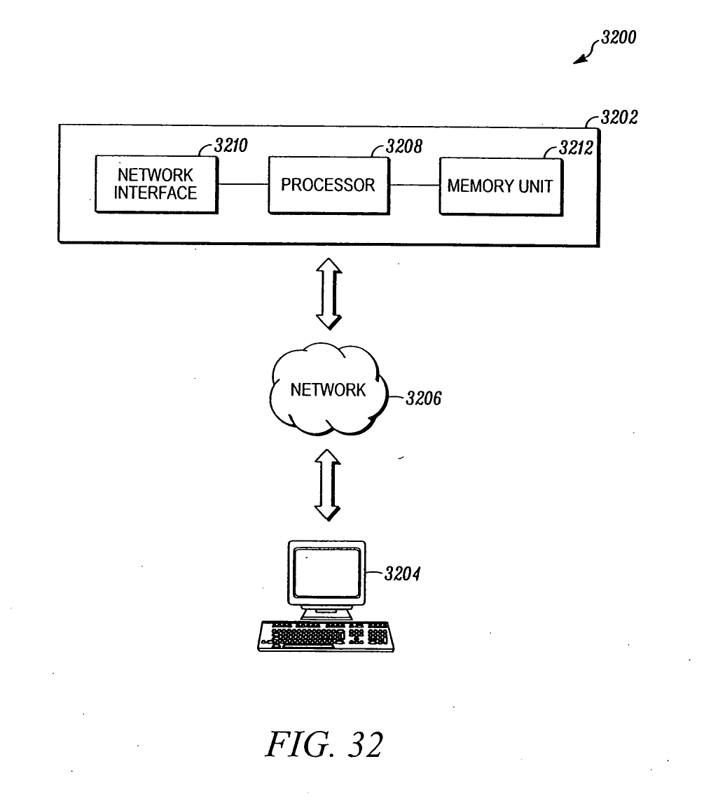

The advertisement campaign management system as described with reference to FIGS. 1 and 2, the graphical user interfaces as described with reference to FIGS. 3-31, and the systems and methods as described with reference to FIGS. 32-44 provide user interfaces and application program interfaces (“APIs”) to an advertisement campaign management system that provides users and machines the ability to flexibly, dynamically, and efficiently manage large groups of advertisements. As opposed to interfaces to advertisement campaign management systems that only provide the ability to manage advertisement campaign information at a user account level or an individual advertisement level, the disclosed advertisement campaign management system provides the ability to manage advertisement campaign information at a level defined by the user. Users are given the ability to define their own groups of advertisement campaign information (an ad group) for advertisements that will be handled by the advertisement campaign management system in a similar manner. For example, users may group advertisements by a search tactic, performance parameter, demographic of a user, family of products, or almost any other parameter desired by the user. Allowing users to define their own ad groups allows the advertisement campaign management system to provide more useful information to the user thereby allowing the user to display, manage, optimize, or view reports on, advertisement campaign information in a manner most relevant to an individual advertiser.

FIG. 1 illustrates one embodiment of a pod of an advertisement (“ad”) campaign management system. Pod 100 comprises a plurality of software components and data for facilitating the planning, management, optimization, delivery, communication, and implementation of advertisements and ad campaigns, as well as for storing and managing user accounts. In one embodiment, a pod 100 comprises a campaign data store (“CDS”) 105 that stores user account information. Application Program Interfaces (“APIs”) 110 and User Interfaces (“UI”) 115 are used for reading data from and writing data to the campaign data store 105. Internal APIs 130 provide shared code and functions between the API and UI, as well as facilitate interface with the campaign data store 105. A keyword suggestion component 120 may assist users in searching for available search terms. An editorial processing system (“EPS”) 125 may be provided to review content of all new ads. A pod collection server (“PCS”) 135 determines which pod the collected ad campaign performance data should go to. A script server 140 provides scripts for collection of data indicative of the customer browsing sessions. An image server 145 receives and processes data indicative of the customer browsing sessions from the customer web browsers.

The pod may further comprise a channel server 150 operative to receive data from one or more advertising channels. A business information group (“BIG”) 155 may provide analysis and filtering of raw click data coming from the advertising channels through the channel server 150. An account monitoring component 160 monitors budgets allocated for each ad campaign. A financial component 165 may be provided for planning and budgeting ad campaign expenses. A weight optimizer 170 operative to optimize individual ad performance. A campaign optimizer 175 may be provided to optimize performance of the ad campaign. A third-party analytical feed component 180 is provided to handle the incoming ad performance data from the third-party sources. A quality score component 185 provides yet another metric for measuring individual ad performance. A forecast component 190 is an analytical tool for predicting keywords trends. Finally, an online sign-up (“OLS”) component 195 provides heightened security services for online transactions involving exchange of moneys.

The CDS 105 is the main data store of pod 100. In one embodiment, CDS 105 stores ad campaign account data, including account access and permission lists, user information, advertisements, data collected from advertiser websites indicative of customer browsing sessions, raw click data received from the advertising channels, third party analytical feeds, ad campaign performance data generated by the system, ad campaign optimization data, including budgets and business rules, etc. In various embodiments of the invention, CDS 105 stores one or more account data structures as illustrated in FIG. 2 and described in greater detail below.

Data in the CDS 105 may be stored and accessed according to various formats, such as a relational format or flat-file format. CDS 105 can be managed using various known database management techniques, such as, for example, SQL-based and Object-based. At the physical level, the CDS 105 is implemented using combinations of one or more of magnetic, optical or tape drives. Furthermore, in one embodiment of the invention, CDS 105 has one or more back up databases that can be used to serve Pod 100 during downtime of CDS 105.

In one embodiment, a pod 100 exposes one or more APIs 110 and UIs 115 which are utilized by the system users, such as advertisers and agencies, to access services of the ad campaign management system, such as for reading data from and writing data to the campaign data store 105. The APIs 110 and UIs 115 may be also provided through a distro component described in detail in U.S. patent application Ser. No. 11/324,129, titled “System and Method for Advertisement Management”, filed Dec. 30, 2005, the entirety of which is hereby incorporated herein by reference. The advertisers and their agencies may use the APIs 110, which in one embodiment includes XML-based APIs, to allow access to the ad campaign management system and data contained therein. In one embodiment, the UI 115 comprises a website or web application(s) for enabling user access to the ad campaign management system. The pod 100 utilizes internal APIs 130, which are shared code and functions between the APIs 110 and UI 115, to facilitate interaction with campaign data store 105.

According to some embodiments, the above-described user and application program interfaces are used to facilitate management and optimization of ad campaigns, which include, but are not limited to, management of listings associated with an auction-based search-term related sponsored search results listings marketplace. For example, advertisers use these interfaces to access ad campaign information and ad campaign performance information saved in the ad campaign data store 105, search the information, analyze the information, obtain reports, summaries, etc. Advertisers may also change listings or bidding strategies using these interfaces, which changes are updated in the campaign data store 105. Furthermore, these interfaces may be used to perform comparisons of the performance of components of ad campaigns, such as performance of particular listings, search terms, creatives, channels, tactics, etc.

While functionality and use of application program interfaces of the pod is described with reference to an auction-based search term-related sponsored listings context, it is to be understood that, in some embodiments, these interfaces may be used with regard to off-line or non-sponsored search ad campaigns and ad campaign performance, or combinations of on-line and off-line ad campaigns information, as well.

A keyword suggestion component 120 provides for keyword suggestion through interfaces 110, 115 for assisting users with ad campaign management based on seed terms or a universal resource locator (“URL”) provided by a user. In one embodiment of the invention, the keyword suggestion component 120 assists users to search for available search terms. As described above, in an auction-based system or marketplace, advertisers bid for search terms or groups of terms, which, when used in a search by customers, will cause display advertisement listings or links among the search results. The keyword suggestion component 120 provides suggestions to advertisers regarding terms they should be bidding. In one embodiment, the keyword suggestion component 120 may look at actual searches conducted in the last month and provide a suggestion based upon previous searches. In another embodiment, the keyword suggestion component 120 may look at the terms other advertisers of similar products or services are bidding on and suggest these terms to the advertiser. In yet another embodiment, the keyword suggestion component 120 may determine terms that customers who bought similar products or services use in their searches and suggest these terms to the advertiser. In another embodiment, the keyword suggestion component 120 may maintain a table of terms divided into several categories of products and services and allow an advertiser to browse through and to pick the available terms. In other embodiments, the keyword suggestion component 120 may use other techniques for assisting advertisers in the term selection process, such as suggesting a new term to the advertiser if the advertised products and services are unique.

The editorial processing system (EPS) 125 ensures relevance and mitigates risks of advertisers' listings before a listing can participate in the auction. In general, the EPS 125 reviews new or revised ads. In one embodiment, the EPS 125 applies a set of business rules that determines accuracy and relevance of the advertiser listings. These rules may be applied automatically by the EPS 125 or through a human editorial review. The EPS 125 may, for example, detect inappropriate content in the advertiser listings or illegally used trademark terms. In one, EPS 125 responds with an annotation such as rejected, approved, rejected but suggested changes, etc.

In one embodiment, EPS 125 may comprise a quick check component. The quick check component performs a preliminary or a “quick check” to determine whether to accept or reject an ad automatically before it is submitted to a human editor and stored in the campaign data store 105. In one embodiment, either API 110 or a UI 115 invokes the quick check component service so that advertiser can receive instant feedback. For example, use of prohibited words, such as “best” in the submitted advertisement, may be quickly detected by the quick check component and, obviating the need for human editorial review. In contrast, using words such as gambling, adult services, etc., the quick check component might determine that the ad requires a more thorough editorial review. One of the benefits of the quick check component is the rapid provision of feedback to the advertiser, which enables the advertiser to revise the listing right away and thus to expedite review by the human editor.

Again with reference to FIG. 1, according to one embodiment, the pod 100 may further comprise a channel server 150, which is operable to receive and process data received from an advertising channel, such as Google.com and MSN.com. This data may include but is not limited to the customer profiles, historical user behavior information, raw impressions, cost, clicks, etc. Additional description of user information and its uses can be found in U.S. Patent Application No. 60/546,699 and Ser. No. 10/783,383, the entirety of which are both hereby incorporated by reference. The channel server 150 may further be operable to re-format the received data into a format supported by the ad campaign management system and to store the reformatted data into the campaign data store 105.

In one embodiment, pod 100 may further comprise a business information group (BIG) component 155. BIG 155 is operable to receive cost, click, and impression data that is coming into the pod 100 from various sources including the channel server 150, pod collection server 135 and third-party analytics feeds component 180. BIG 155 assures that this data is received in a correct and timely manner. In one embodiment, BIG 155 may also perform aggregation and filtering on raw data impressions and clicks that are coming into the pod 100. BIG 155 may be further operable to store the collected and processed data into the Campaign Data Store 105. In other embodiments, BIG 155 may also perform internal reporting, such as preparing business reports and financial projections according to teaching known to those of skill in the art. To that end, in one embodiment, BIG 155 is operable to communicate with the Account Monitoring component 160, which will be described in more detail next.

In one embodiment, the pod 100 may further comprise an account monitoring component 160. This component 160 may be operable to perform budgeting and campaign asset allocation. For example, the account monitoring component 160 may determine how much money is left in a given advertiser's account and how much can be spent on a particular ad campaign. In one embodiment, the account monitoring component 160 may employ a budgeting functionality to provide efficient campaign asset allocation. For example, an advertiser may set an ad campaign budget for a month to $500. The account monitoring component 160 may implement an ad bidding scheme that gets actual spending for that month as close to $500 as possible. One example of a bidding scheme employed by the account monitoring component 160 would be to lower the advertiser's bids to reduce how often the advertiser's ads are displayed, thereby decreasing how much the advertiser spends per month, which may be performed dynamically. Another example of budgeting by the account monitoring component 160 is to throttle the rate at which advertisements are being served (e.g., a fraction of the time it is served) without changing the advertiser's bid (whereas in the previous example the bid was changed, not the rate at which advertisements were served). Another example of throttling is to not serve an ad as often as possible but put it out according to a rotation.

In one embodiment, the pod 100 may further comprise a financial component 165, which may be an accounting application for planning and budgeting ad campaign expenses. Using the financial component 165 advertisers may specify budgets and allocate campaign assets. The financial component 165 provides an advertiser with the ability to change distribution of campaign budget and to move money between different campaigns. The financial component 165 may also present advertisers with information on how much money is left in the account and how much can be spent on a particular ad campaign. In some embodiments, the financial component 165 may further be operable to provide advertisers with information regarding profitability, revenue, and expenses of their ad campaigns. The financial component 165 may, for example, be implemented using one or more financial suites from Oracle Corporation, SAP AG, Peoplesoft Inc., or any other financial software developer.

In one embodiment, pod 100 may further comprise an online sign-up (OLS) component 195. The OLS component 195 may be operable to provide advertisers with a secure online sign-up environment, in which secure information, such as credit card information, can be exchanged. The secure connection between the advertiser computer and the OLS component 195 may be established, for example, using Secure Hypertext Transfer Protocol (“SHTTP”), Secure Sockets Layer (“SSL”) or any other public-key cryptographic techniques.

In one embodiment, the pod 100 may further comprise a quality score component 185 that calculates one or more values such as an ad clickability score and a quality score. An ad clickability score is one of the ad performance parameters whose value represents a quality of an ad at the time the advertisement service provider serves the ad. The ad clickability score is internal to the ad campaign management system and is typically not exposed external to the ad campaign management system. A quality score is one of the ad performance parameters that is exposed externally from that ad campaign management system and may be used by the search serving components, such as advertising channels and search engines, to qualify the relative quality of the displayed ads. Thus the quality score is calculated by the search serving components and fed into the ad campaign management system through the quality score component 185 in accordance with one embodiment of the present invention. In some embodiments, the quality score is displayed to the advertiser, so that the advertiser may revise the ad to improve its quality score. For example, if an ad has a high quality score, then the advertiser knows not to try to spend money and time trying to perfect the ad. However, if an ad has a low quality score, it may be revised to improve ad's quality score.

In one embodiment, the pod 100 further comprises a forecasting component 190, which is an analytical tool for assisting the advertiser with keyword selection. In some embodiments, the forecasting component is operable to predict keywords trends, forecast volume of visitor traffic based on the ad's position, as well as estimating bid value for certain ad positions.

In one embodiment, the forecasting component 190 is operable to analyze past performance and to discover search term trends in the historical data. For example, the term “iPod” did not even exist several years ago, while now it is a very common term. In another embodiment, the forecasting component 190 performs macro-trending, which may include forecasting to determine terms that are popular in a particular region, for example, California, or with particular demographic, such as males. In yet another embodiment, the forecasting component 190 provides event-related macro- and micro-trending. Such events may include, for example, Mother's Day, Christmas, etc. To perform event-related trending for terms related to, for example, Mother's Day or Christmas, the forecasting component 190 looks at search patterns on flower-related terms or wrapping paper terms. In other embodiments, the forecasting component 190 analyzes the historic data to predict the number of impressions or clicks that may be expected for an ad having a particular rank. In another embodiment, the forecasting component 190 is operable to predict a bid value necessary to place the ad in a particular position.

In one embodiment, the pod 100 further comprises a weight optimizer 170, which may adjust the weights (relative display frequency) for rotating elements as part of alternative ad (“A/B”) functionality that may be provided by the ad campaign management system in some embodiments of the present invention. The A/B testing feature allows an advertiser to specify multiple variants of an attribute of an ad. These elements may include creative (title, description and display URL), destination (landing URL) and perhaps other elements such as promotions and display prices. More specifically, when an end-user performs a search, the ad campaign management system assembles one of the possible variants of the relevant ad and provides it to the advertising channel for display to the end-user. The ad campaign management system may also attach tracking codes associated with the ad, indicating which variant of each attribute of the ad was actually served. The behavior of the end-user then may be observed and the tracking codes may be used to provide feedback on the performance of each variant of each attribute of the ad.

In determining the weight for a particular element, the weight optimizer component 170 may look at actual performance of ads to determine optimal ads for delivery. The weight optimizer component 170 operates in multiple modes. For example, in Optimize mode the weight (frequency of display) of each variant is changed over time, based on the measured outcomes associated with each variant. Thus, the weight optimizer component 170 is responsible for changing the weights based on the measured outcomes. The weight optimizer component may also operate according to Static mode, in which the weights (frequency of display) of each variant are not changed by the system. This mode may provide data pertaining to measured outcomes to the advertiser. The advertiser may have the option to manually change the weights.

The pod 100 may further comprise a campaign optimizer component 175, which facilitates ad campaign optimization to meet specific ad campaign strategies, such as increasing number of conversions from displayed ads while minimizing the cost of the campaign. To that end, in some embodiments, campaign optimizer component 175 uses data received from the channel server 150, forecasting component 190, third party analytics feed component 190, quality score component 185, and BIG 155 to determine how much to bid on which ads, how to allocate the budget across different ads, how to spend money over the entire period of the campaign, etc. Furthermore, campaign optimization not only focuses on executing ads efficiently, but also performing arbitrage between ads across various channels and tactics to determine where the limited ad campaign budget is most effective.

In one embodiment, the campaign optimizer component 175 analyzes the obtained analytics data, including ad campaign information, ad campaign performance information, as well as potentially other information, such as user information, to facilitate determining, or to determine, an optimal ad campaign strategy. Herein, an “optimal” ad campaign strategy includes any ad campaign strategy that is determined to be optimal or superior to other strategies, determined to be likely to be optimal, forecasted or anticipated to be optimal or likely to be optimal, etc. In some embodiments, optimizing is performed with respect to parameters, or a combination of parameters, specified by an advertiser, supplied automatically or partially automatically by the ad campaigns facilitation program, or in other ways.

In addition to the foregoing, ad campaign strategy may include any course of action (including, for example, changing or not changing current settings or strategy) or conduct, or aspects or components thereof, relating to an ad campaign. An ad campaign strategy may include a recommendation regarding a course of action regarding one or more aspects or parameters of an ad campaign, and may include an immediate course of action or set of parameters, or a course of action or set of parameters for a specified window of time. For example, an optimal ad campaign strategy in the context of an auction-based search result listings situation, may include recommendations relating to bidding and bid hiding rates in connection with an auction or marketplace relating to search term or group of terms in connection with sponsored listings.

In some embodiments, the campaign optimizer component 175 may be operable to analyze ad campaign performance information to determine an optimal ad campaign strategy. Ad campaign performance information may include a variety of information pertaining to historical performance of an ad campaign, channel, tactic, or ad or group of ads. Ad campaign performance information can include many types of information indicating or providing a suggestion of how effectively ads, or ads presented though a particular channel, etc., influence or are likely to influence user or consumer behavior. For example, an advertising channel such as Yahoo! may collect performance information with respect to a particular sponsored search result listing. The information may include a number or percentage of viewers who clicked on the link, or who shopped at or purchased a product at the advertisers Web site as a result of the listing, etc.

The campaign optimizer component 175 may be operable to analyze ad campaign information to determine an optimal ad campaign strategy. Ad campaign information may include campaign objectives or budget-related conditions or constraints, or can include information specifying, defining, or describing ads themselves, channels, tactics, etc. With regard to auction-based sponsored search result listings, ad campaign information can include bidding parameters such as maximum or minimum bids or bidding positions (rankings or prominence of listings) associated with a term or term cluster, for instance, as further described below. Such ad campaign information can also include campaign objectives, quotas or goals expressed, for example in metrics such as ROAS (return on ad spend), CPI (clicks per impression), or in other metrics, and with respect to individual ads, terms or term groups, channels, tactics, etc.

The campaign optimizer component 175 may further include bid optimization functionality, which may be used by the system to determine a desirable or optimal bid for a listing, such as a paid search result. The bid optimization functionality of the campaign optimizer component 175 may be used to constrain the set targets and constraints on the bids set by an advertiser. The constraints may include a maximum bid and a minimum bid. The targets may be associated with the listing and can be specified in terms of one or more metrics related to the performance of the listing. The campaign optimizer component 175 may analyze recent past analytics in connection with the metric and specify a bid recommendation forecasted by the bid optimizer functionality to achieve the target or get as close to the target as possible. In some embodiments, the campaign optimizer component 175 can also provide a recommendation for a listing, which may include a maximum bid and an update period, which update period can be a time between maximum bid hiding updates. In other embodiments, the campaign optimizer component 175 can also provide a recommendation including a range of values that should allow the listing to obtain a premium position when served, such as a first page listing.

To facilitate ad campaign management and optimization, the pod 100 is further operable to collect visitor state data from the advertiser websites in accordance with a preferred embodiment of the ad campaign management system. To that end, the pod 100 utilized pod collection server 135, script server 140, and image server 145 to collect visitor state data and to store the same in the campaign data store 105. The collected visitor state data may then be used by various components of the pod 100 including, but not limited to, campaign optimizer component 175, forecasting component 190, and BIG 155 to generate ad campaign performance data in accordance with various embodiments of the present disclosure.

The various methods of data collection in accordance with various embodiments of the present invention may include, but are not limited to, full analytic, campaign only, conversion counter and sampling. In one embodiment, full analytics collection provides the most robust collection method. The full analytics collection collects marketing-based and free search-based leads. As a result, the advertiser may see a complete picture of how leads and conversions are generated. Primarily, the full analytics collection method provides a full funnel report that will provide a key view into how visitors of the advertiser website go from being a lead through to browser, prospect, and finally to a conversion event. Visitor state storage on Campaign Data Store 105 may also allow for repeat and return customer report data and for a full suite of accreditation methods.

In another embodiment, a campaign only analytics collection method is much like full analytic but only paid marketing events are tracked and result events generated from free search are ignored or discarded. This has the advantage of providing funnel and repeating visitor reports as well as a reduced data collection and storage rate. The campaign only analytics method provides a balance of rich report data and reduced collection, processing, and storage cost.

In yet another embodiment, the conversion counter method is the most simple analytics data collection available. With conversion counter analytics, the advertiser places a tag on pages where value is generated for the advertiser, such as revenue. The image server 145 places the lead “stack” in a cookie, which may be used to accredit the proper term/creative to the conversion event. This data collection mechanism generates enough data to provide optimization on creative weighting. It should be further noted that in one embodiment a direct accreditation method may be applied to the conversion counter method. In the conversion counter approach, no visitor state storage is needed and only conversion events are received. Thus, this approach has a minimal effect on pod 100 load and data storage requirements. In another embodiment, a sampling method is utilized. In accordance with this method, only a random number of unique visitors, for example, 10%, are tracked, which reduces data collection and storage.

In order to allow for accreditation of the lead generation source to a conversion event, the state of the customer session on the advertiser's website may be maintained. Accreditation is the process by which all the marketing events are tied to a specific, or set of specific, marketing activities. There are two known approaches that may be utilized for storage of visitor state: client-side cookies and server-side database.

In one embodiment, cookies may be used as an exemplary client-side visitor state storage. When cookies are used to store visitor state one of two methods may be used to store visitor state. A redirection server used on the lead generating event may add the visitor state to the cookie at the click event. Alternatively a collection server may set the cookie at the time of a lead event. While visitor state in the cookie approach is the most cost effective it has several disadvantages. Generally, cookies have low storage requirements and thus an active search user (typically, most valuable users because they generate the most revenue) could lose accreditation information as their lead stack grows and causes some older events to be pushed out. As a result, a conversion event could occur where the lead information was lost in the stack and thus the accreditation is lost. Furthermore, cookie-off users are essentially invisible to the system. Moreover, efficacy is reduced due to the additional time needed to parse the collection server request when the cookie is set, which may cause end users to click away from the lead page before the cookie can be completed. Finally, cookie based visitor state storage prevents any internal analysis of user behavior.

In another embodiment, server-side database, such as the CDS 105, may be used to store visitor state. Using server side storage in a database offers the high efficacy rates but at the additional cost of the storage. Using server side storage of visitor state allows the ad campaign management system to have more advanced accreditation models, which could allow for assist-based accreditation. Efficacy rates over cookie based visitor state storage are increased due to many factors. Primarily the system is no longer limited in the amount of visitor state storage a single user can have so no lead loss would occur. Cookies off users can still be traced as unique visitors so they can still be tracked (although at a reduced rate of accuracy) and thus are able to be included. Collection event processing latency is greatly reduced because the event can be just logged and then actually processed later. With the cookie approach lead accreditation has to occur at the time the event is received because the cookie must be evaluated before the request is returned by the beacon servers. Furthermore, with visitor state stored in the campaign data store, valuable marketing data can be collected and analyzed for internal use.

In one embodiment, the ad campaign management system utilizes a combination of the above-described client-side cookies and server-side database techniques to collect and maintain visitor state data. In particular, as indicated above the pod 100 utilizes pod collection server 135, script server 140, and image server 145 to collect visitor state data and to store the same in the campaign data store 105. In one embodiment, the pod collection server 135, script server 140 and image server 145 may be implemented, for example, as Java servlets.

FIG. 2 is a diagram of one embodiment of a model for the maintenance of ads according to the ad campaign management system of FIG. 1. As depicted, an ad campaign management system comprises a data store 200 that facilitates hierarchical storage of ad campaign data, providing advertisers with multiple levels of structure for control of advertisement content. In particular, an advertiser utilizing services of the ad campaign management system may be provided with a master account 205 for receiving aggregated analytics relating to the master account 205 and managing or optimizing Web properties 210 and advertisements within the master account 205 based on the aggregated analytics. A Web property 210 may include a website, or a combination of related websites and pages for which the advertiser is advertising. Furthermore, within master account 205, an advertiser may create several accounts 220 to separately manage ad campaigns, as well as to collect ad performance information.

To facilitate tracking and collection of ad performance data from Web properties 210, data store 200 further maintains custom tags, program code, navigation code, etc. 215. According to one embodiment, a tag 215 may comprise a piece of code that is created by the system and placed on relevant Web pages of a given website to allow automatic tracking and collection of data indicative of customer session on the advertiser website. For example, a tag may be used to track user visits, interaction, or purchases from a website to which a user navigates as a result of clicking on an advertisement link associated with the website. Depending on specific needs and business objective of a given advertiser, tags may be coded to collect specific information about the customer session that is of interest to the advertiser. Thus, some tags may enable collection of data on numbers of raw clicks on the advertiser website, while others tags may track numbers of clicks that resulted in conversions, e.g., purchase of a product or service from the advertiser website. Those of skill in the art will recognize that data collection may be limited to other portions of the customer session.

Some embodiments utilize, or may be combined with, features or technologies, such as, for example, HTML tagging, data tracking, and related technologies, as described in U.S. patent application Ser. Nos. 09/832,434 and 09/587,236, the entirety of which are both hereby incorporated herein by reference.

In one embodiment, within a master account 205, an advertiser may maintain one or more accounts 220, which may be used to receive analytics related to a specific account 220 and manage ad campaign spending associated with individual Web properties 210. Thus, accounts 220 allow advertisers to distribute their advertising funding between different Web properties 210 and between separate ad campaigns 225. A given ad campaign 225 may include a set of one or more advertising activities or conduct directed to accomplishing a common advertising goal, such as the marketing or sales of a particular product, service, or content, or group of products, services or content. Two ad campaigns may be considered disparate when the ad campaigns are directed to different advertising goals. For example, an advertiser may wish to advertise a product for sale and a service associated with this product. Thus, the advertiser may store separate ad campaigns 225 for advertising the product and the service.

In one embodiment, storage of an ad campaign 225 may be further subdivided into several ad groups 230. An ad Group 230 may be thought of as a conceptual compartment or container that includes ads and ad parameters for ads that are going to be handled in a similar manner. An ad group 230 may allow for micro-targeting, e.g., grouping ads targeted to a given audience, a demographic group, or a family of products. For example, an ad group may be related to a given manufacturer's products, such as Sony, Microsoft, etc. or a family of high-end electronics, such as TVs, DVDs, etc. There is a number of ways in which a given group of ads may be managed in a similar manner. For example, an advertiser may specify that there be a certain markup (e.g., 50%) on items in a given ad group, may want to distribute all those ads in a certain way, or may want to spend a certain amount of its budget on those advertisements. Further, an ad group 230 provides a convenient tool for an advertiser to move a large group of ads and ad parameters from one ad campaign 225 to another ad campaign 225, or to clone a large group of ads and ad parameters from one ad campaign 225 to another ad campaign 225.

In one embodiment, changes made to the parameters of a given ad group 230 may apply to all ads within the given ad group. For example, one such parameter may be pricing. For a sponsored search, an advertiser may set the default price for the whole ad group but may override the price on each individual term. Similarly, an advertiser may further specify that certain terms are low value, but decide to increase the amount spent on another term uniformly across all ads in a given ad group. Thus, storage according to one or more ad groups 230 enables advertisers to bridge the gap between ad campaigns and the individual ads comprising a given ad campaign.

A given ad may contain one or more items of advertising content that are used to create ads/terms in an ad group, including, but not limited to, creatives (e.g., titles, descriptions) and destination URLs (plus associated URL tracking codes). Optionally, a given ad may contain a {KEYWORD} token for substitution of alternate text in the title, description, or other ad component. Furthermore, ads may exist as a template in an ad library (not pictured) that can be reused across ad groups or a local ad that is used and stored only within a specific ad group. The ad library, which may be provided by the ad campaign management system, allows advertisers to store ad templates, sharing and reusing them across campaigns and ad groups. Ads in the ad library may be shared within an account, e.g., each account has its own library.

An ad group 230 may utilize numerous tactics for achieving advertising goals. The term “tactic” includes a particular form or type of advertising. For example, in on-line advertising, tactics may include sponsored search result listings 235, banner advertisements 255, content match 270, etc. In off-line advertising, tactics may include television commercials, radio commercials, newspaper advertisements, etc. In different embodiments, tactics may include subsets or supersets of the listed examples or other examples. For instance, on-line advertising is an example of a broader tactic than the narrower tactic of sponsored search result listings. Furthermore, the advertiser may utilize multiple advertising channels for different tactics. For example, the advertiser may utilize sponsored search listings in several websites or portals, such as Yahoo!, Google.com, MSN.com, etc. In one embodiment, a user may set parameters within the ad group 230 to place a spend limit for each type of advertising tactic comprising the ad group 230.

One example of an advertising tactic is sponsored search 235. According to one embodiment, sponsored search 235 operates as follows: an auction-based system or marketplace is used by advertisers to bid for search terms or groups of terms, which, when used in a search, causes the display of a given advertiser's ad listings or links among the display results. Advertisers may further bid for position or prominence of their listings in the search results. With regard to auction-based sponsored search 235, a given advertiser may provide a uniform resource locator (URL) 240 to the webpage to which the ad should take the customer if clicked on, as well as the text of the advertisement 245 that should be displayed. Advertiser may further identify one or more terms 250 that should be associated with the advertisement 245.

Another example of advertising tactic is content match 270. Storage of content match advertisements 280 may be used by the advertiser to complement, or as alternative to, the sponsored search tactic 235. Ads stored according to the content match tactic 270 are displayed alongside relevant articles, product reviews, etc, presented to the customers. For the content match tactic 270, data store 200 stores one or more URLs 275 identifying the address of a webpage where given ad should take the customer if clicked on, as well as the text, image, video or other type of multimedia comprising the creative portion of the advertisement 280.

Yet another example of an advertising tactic is banner ad 255. Banner ad tactic 255 may be used by the advertiser to complement, or as alternative to, the sponsored search tactic 235 and content match tactic 270. In contrast to the sponsored search tactic and content match tactic, which are usually based on a pay-per-click payment scheme, an advertiser pays for every display of the banner ad 265, referred to as an impression. Alternatively, if the banner ad displays a phone number, advertiser may only be billed when a user calls the phone number associated with the advertisement. Thus, for the banner ad tactic, the data store 200 maintains a URL 260 to the webpage where the ad should take the customer if clicked on, as well as the creative that comprises the banner ad 265.

The data store 200 of the ad campaign management system may further store various parameters for each ad group. Such parameters may include, for example, maximum or minimum bids or bidding positions (rankings or prominence of listings) associated with a term or term cluster for the particular ad group or ads within a given ad group. As described above, in embodiments of an auction-based sponsored search result listings environment, prominence or rank of listings is closely related to ad performance, and therefore a useful parameter in ad campaign management. The rank of a given ad determines the quality of the placement of the ad on pages that are displayed to customers. Although details vary by advertising channel, top-ranked listings typically appear at the top of a page, the next listings appear in the right rail and additional listings appear at the bottom of the page. Listings ranked below the top five or so will appear on subsequent search results pages.

There is a correlation between rank and both number of impressions and click-through rate (clicks per impression), which provides an opportunity for advertisers to pay more per click (get a higher rank) in order to get more visitors to their web site. The result is that an advertiser may determine, how much the advertiser should be willing to bid for each listing based on the advertiser's business objectives and the quality of the traffic on their web site that is generated by the listing. This information may also be stored for a given ad group 230 in the data store 200 of the ad campaign management system of the present invention.

FIGS. 3-31 are examples of different embodiments of graphical user interfaces (“GUIs”) 115 to the advertisement campaign management system of FIG. 1 that provide a user the ability to display, manage, optimize, or view and customize reports on, advertisement campaign information. As used herein, advertisement campaign information may comprise information such as current or historical performance of an advertisement or one or more groupings of advertisements; campaign objectives relating to an advertisement or one or more groupings of advertisements; budget-related conditions or constraints relating to an advertisement or one or more groupings of advertisements; information specifying, defining, or describing an advertisement; bidding parameters such as maximum or minimum bidding positions associated with an advertisement or one or more groupings of advertisements; metrics such as return on ad spend (“ROAS”), cost per click (“CPC”), or clicks per impression (“CPI”) associated with an advertisement or one or more groupings of advertisements; cost per acquisition (“CPA”) or any other parameter associated with advertisements or one or more groupings of advertisement provided by an advertisement service provider.

FIG. 3 is an example of one embodiment of a GUI displaying advertisement campaign information. Generally, the GUI 300 provides a high level summary of an account, a high level summary of at least a portion of the ad campaigns and ad groups within a user account, a graphical illustration of performance parameters related to the user account, and a listing of any alerts associated with the user account.

In one embodiment, the GUI 300 comprises an alert section 302, a account summary performance section 304, and an ad campaign/ad group summary section 306. The alert section 302 may comprise one or more notifications 308 to a user. The one or more notifications 308 may relate to a user account as a whole, an ad campaign of the advertiser account, an ad group of an ad campaign, an individual advertisement, or any other grouping of information defined by an advertiser or an advertisement service provider. For example, the one or more notifications 308 may alert the user that a keyword has been declined, that a credit card associated with the user account is about to expire, that an advertisement has been rejected, or any other type of alert desired by an advertisement service provider. Further, the alert section 302 may comprise a drop down menu 310 to filter the one or more notifications 308 based on a user account as a whole, an ad campaign, an ad group, an individual advertisement, or any other grouping of information defined by an advertiser or advertisement service provider.

The account summary performance section 304 may comprise a graph 312 illustrating performance parameters for the account over a period of time. Exemplary performance parameters include impressions, clicks, acquisitions, or revenue relating to a user account as a whole, an individual advertisement, an ad group, an ad campaign, or any other grouping of information defined by an advertiser or an advertisement service provider. In addition to the graph 312, the account summary performance section 304 may also comprise a numerical listing 314 of performance parameters such as impressions, clicks, acquisitions, or revenue relating to a user account as a whole, an ad campaign, an ad group, an individual advertisement, or any other grouping of information defined by an advertiser or an advertisement service provider.

The ad campaign/ad group summary section 306 may comprise one or more summaries of ad campaigns and ad groups 316 which may be filtered according to a drop-down menu filter 317. The drop-down menu filter 317 may allow a user to filter the summaries of the ad campaigns and ad group 316 based on an ad campaign, an ad group, top performing ad groups, a search tactic, or any other grouping of information defined by an advertiser or an advertisement service provider. In FIG. 3, the one or more summaries of ad campaigns and ad groups 316 are filtered according to the top target groups (top ad groups). The summaries of the ad campaigns and ad groups 316 may comprise information relating to the name of an ad campaign 320, the name of an ad group 322 associated with the ad campaign 320, a top performing advertisement 323, a search tactic of the ad campaign and ad group 324, a number of impressions of the advertisements within the ad group 326, a click-through-rate (“CTR”) of the ad group 328, the number of clicks on advertisements within the ad group 330, the cost-per-click (“CPC”) of the advertisements within the ad group 332, the amount spent by a user on the advertisements within the ad group 334, or any other performance parameter provided by an advertisement service provider relating to an ad campaign or an ad group. A top performing advertisement 322 may be an advertisement having a highest performance parameter within the ad campaign or ad group as defined by the advertiser or advertiser service provider, such as the advertisement with the highest number of impressions, highest CTR, or the largest number of clicks.

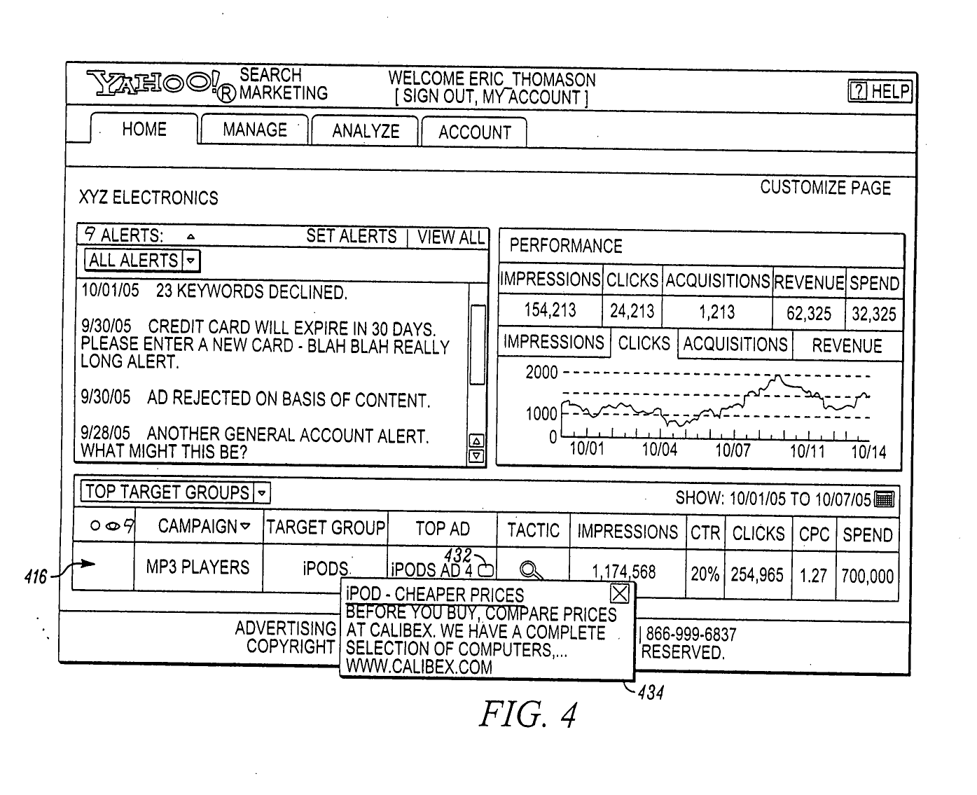

The ad campaign/ad group summary section 306 may additionally comprise a date range selection tool 336. By activating the date range selection tool 336, a user may choose a date range over which they would like to view the performance parameters listed in the ad campaign/ad group summary section 306. For example, the user may choose to view performance parameters over the last 24 hours, over the last month, for a two-week period a month ago, or any other period of time defined by the user. It will be appreciated that the date range selection tool 336 may be applied to other GUIs described below with respect to FIGS. 4-31.

FIG. 4 is an example of another embodiment of a GUI displaying advertisement campaign information. FIG. 4 illustrates that when displaying advertisement information based on one or more ad campaigns and ad groups 416 as in FIG. 3, a user may actuate one or more hyperlinks 432 to dynamically create a secondary GUI 434. The secondary GUI 434 may comprise information such as a top performing advertisement.

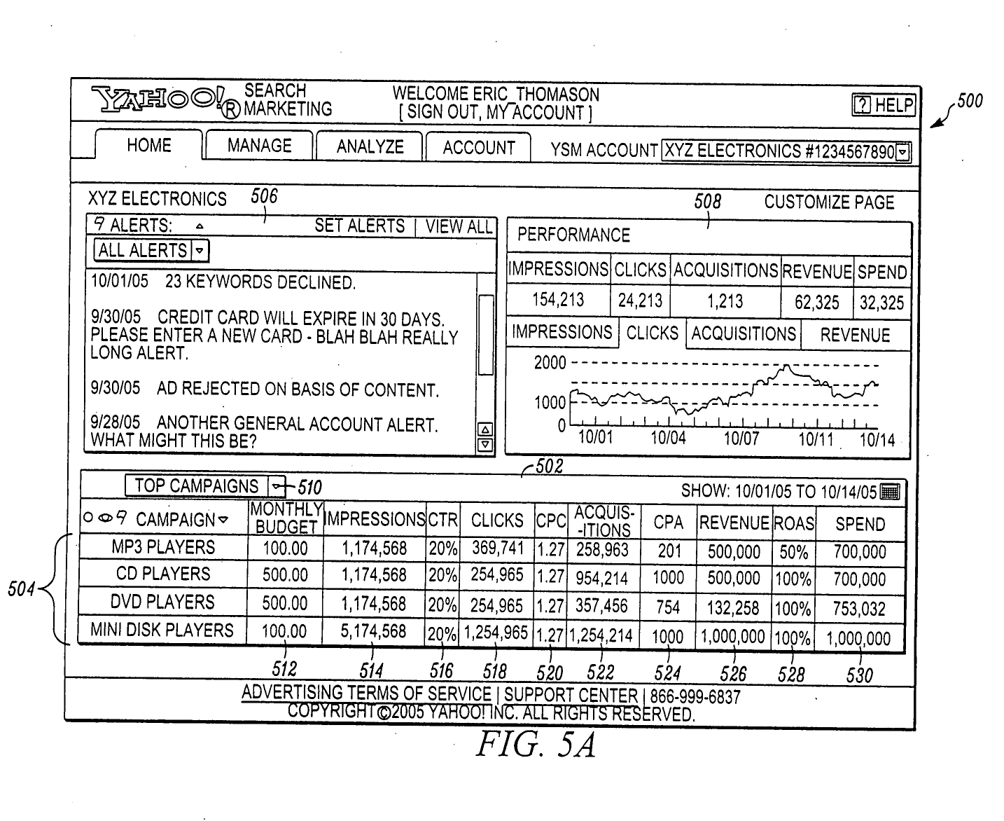

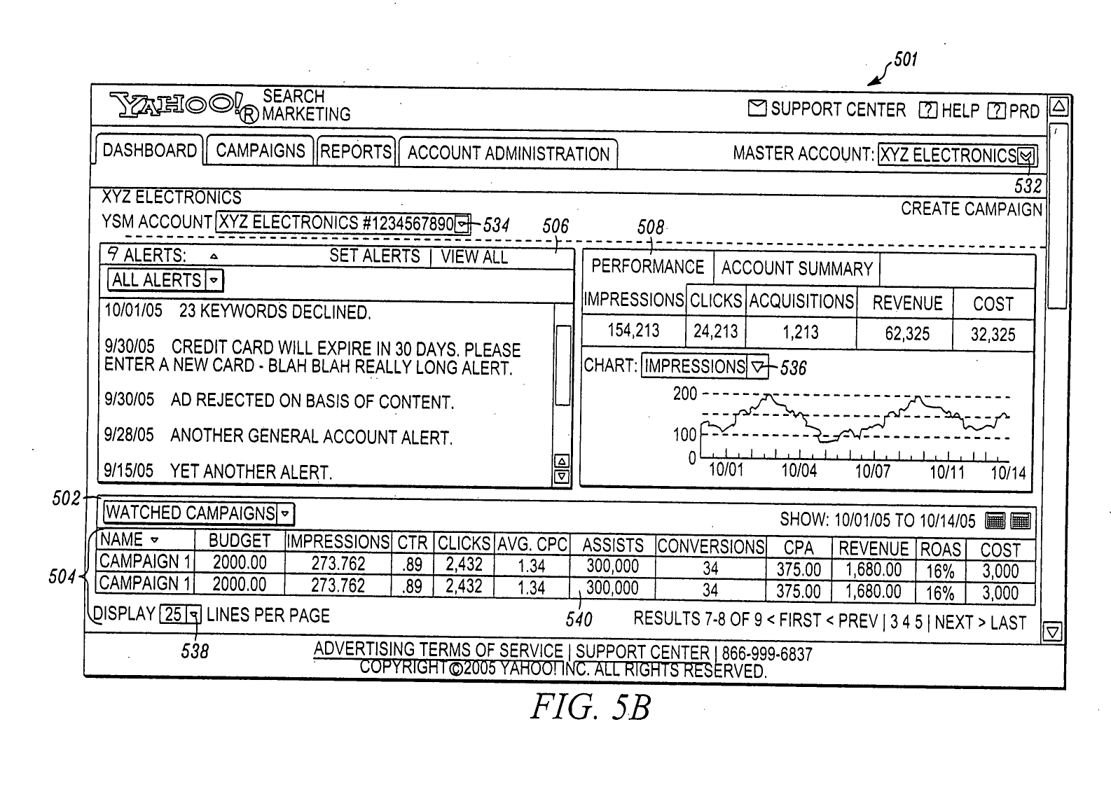

FIGS. 5a and 5b are examples of embodiments of a GUI displaying advertisement campaign information. In FIG. 5a, the GUI 500 comprises an ad campaign summary section 502 that lists summaries of one or more ad campaigns 504, in addition to an alert section 506 and a performance section 508 similar to the alert and performance sections described above with respect to FIG. 3. The summaries of the one or more ad campaigns 504 in FIG. 5 are filtered according to the top performing ad campaigns 510. Each summary of an ad campaign may comprise numerical listings of performance parameters associated with ad campaigns such as a monthly budget 512, a number of impressions 514, a clickthrough rate (“CTR”) 516, a number of clicks 518, a cost per click (“CPC”) 520, a number of acquisitions 522, a cost-per-acquisition (“CPA”) 524, revenue 526, return on ad spend (“ROAS”) 528, the amount spent on the ad campaign 530, or any performance parameter provided by an advertisement service provider.

In FIG. 5b, the GUI 501 comprises an ad campaign section 502 that lists summaries of one or more ad campaigns 504, in addition to an alert section 506 and a performance section 508 similar to the alert and performance sections described above with respect to FIGS. 3 and 5a. The GUI 501 additionally includes a drop-down menu 532 to select a master account and a drop-down menu 534 to select an account within the selected master account. The ad campaign management system typically organizes accounts in a hierarchical manner such that multiple accounts are associated with a single master account.

The GUI 501 additionally includes a drop-down menu 536 to choose a performance parameter to graph in the performance section 508 and a drop-down menu 538 to select a number of campaign summaries displayed in the ad campaign section 502 at one time. Similar to the campaign summaries described above, the campaign summaries include performance parameters relating to an ad campaign such as an assist 540. A number of assists for a campaign is a number of times that a potential completed a conversion for a related product or service after previously searching for information related to the campaign. For example, a potential may first search a first search term and not complete a conversation. However, the potential may then search a second term related to the first term and complete a conversion. When this occurs, the first term is given an assist in the conversion even though the potential completed the conversion after searching the second term. A number of assists may be calculated on a master account, account, ad campaign, ad group, or individual advertisement or keyword level, or any other level defined by an advertiser.

It should be appreciated that any of the drop-down menus described with respect to FIG. 5b may be used with any of the user interfaces described in FIGS. 3-31.

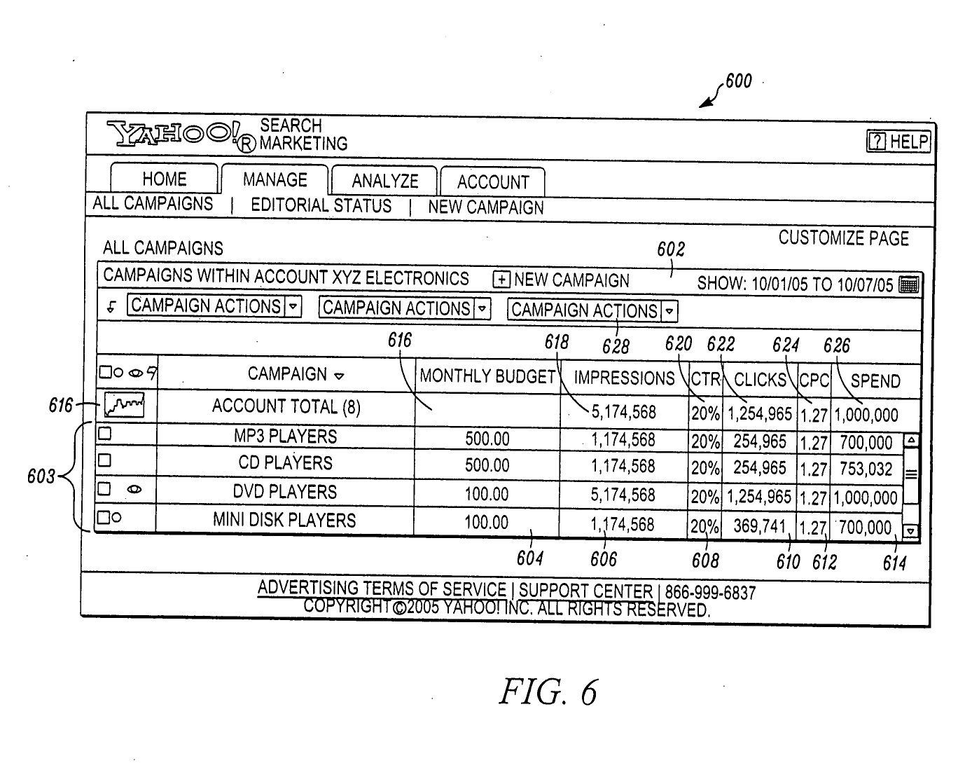

FIG. 6 is an example of one embodiment of a GUI for displaying and managing advertisement campaign information. Generally, the GUI 600 of FIG. 6 comprises an ad campaign summary section 602 comprising summaries of one or more ad campaigns 603 within an advertiser account. Each of the one or more summaries of ad campaigns 603 may comprise performance parameters associated with the ad campaign such as a monthly budget 604, a number of impressions 606, a CTR 608, a number of clicks 610, a CPC 612, an amount spent on an ad campaign 614, or any other performance parameter provided by an advertisement service provider that relates to an ad campaign. The GUI 600 may also comprise a summary bar 616 that comprises the aggregate information of all the advertisement campaign information displayed for the one or more ad campaigns 603. For example, the summary bar 616 may comprise the aggregate monthly budget 616, aggregate number of impressions 618, aggregate CTR 620, aggregate number of clicks 622, aggregate CPC 624, a total amount spent on all ad campaigns 626, or any other performance parameter provided by an advertisement service provider relating to an ad campaign.

The GUI 600 may additionally comprise one or more ad campaign action hyperlinks 628. By selecting one or more ad campaigns and activating the one or more ad campaign action hyperlinks 628, a user may be able to perform actions such as pause an ad campaign, activate an ad campaign, delete an ad campaign, group multiple campaigns into one campaign, clone an ad campaign, add an ad campaign to a watch list, remove an ad campaign from a watch list, or any other functions that can be performed on an ad campaign as a whole.

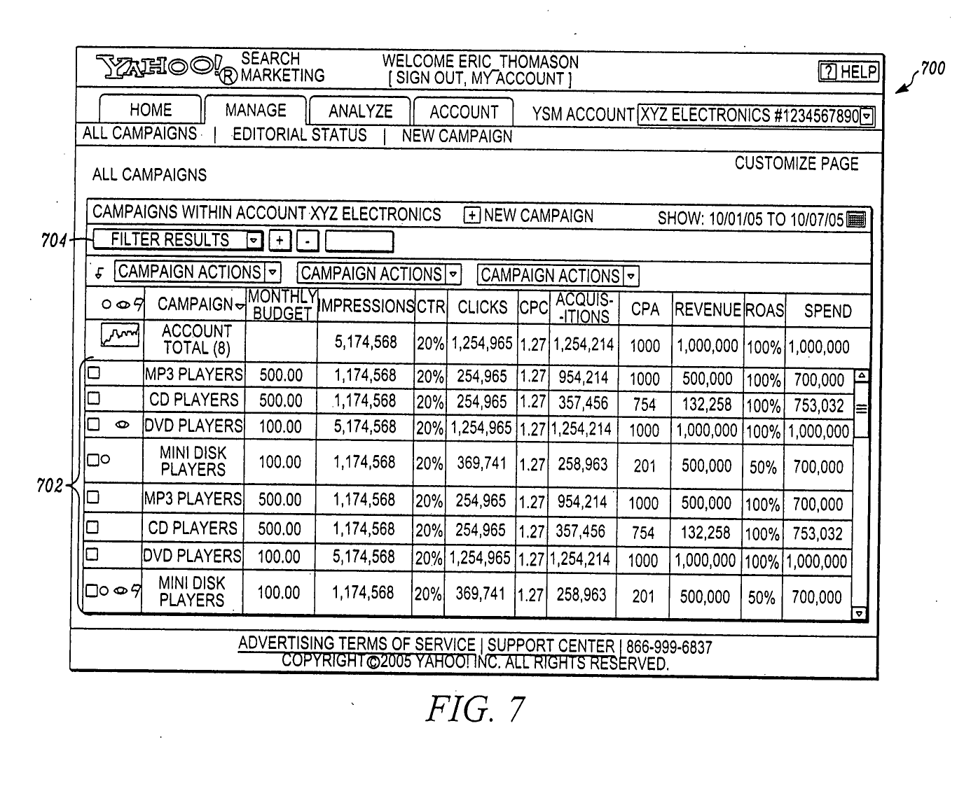

FIG. 7 is an example of another embodiment of a GUI for displaying and managing advertisement campaign information. As in the GUI of FIG. 6, the GUI 700 displays a summary of one or more ad campaigns 702 within an advertiser account. The GUI 700 may also comprise a filter bar 704 to allow a user to sort and view the ad campaign summaries according to performance parameters, ad groups, or any other parameter provided by an advertisement service provider associated with an ad campaign.

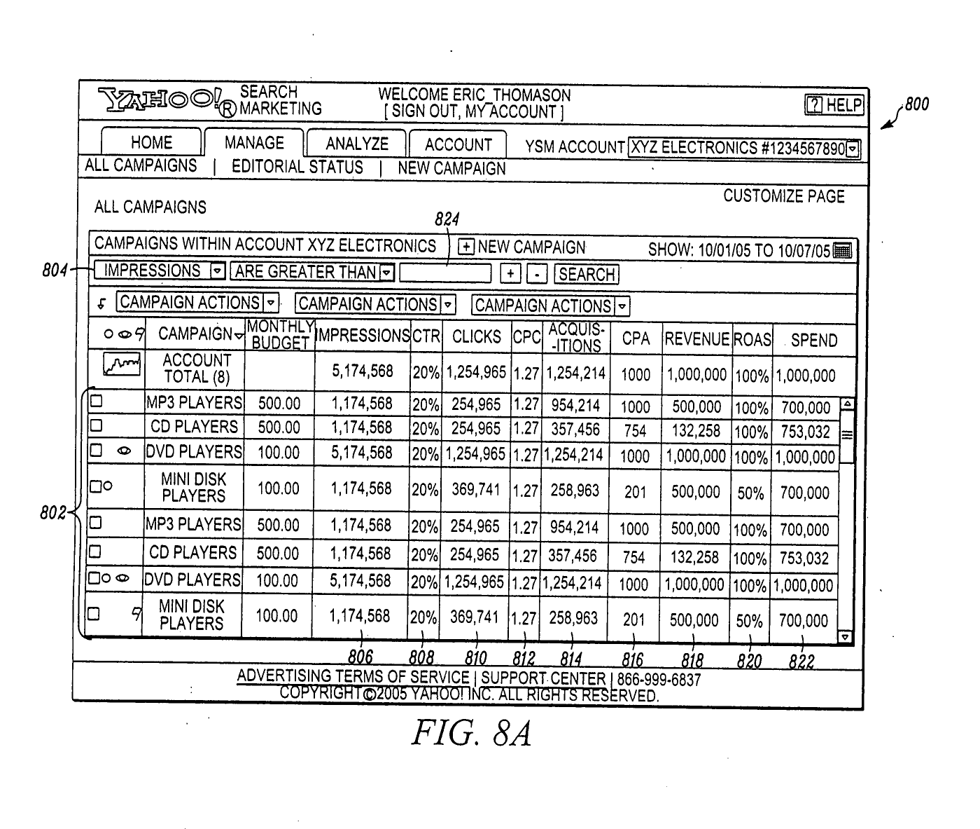

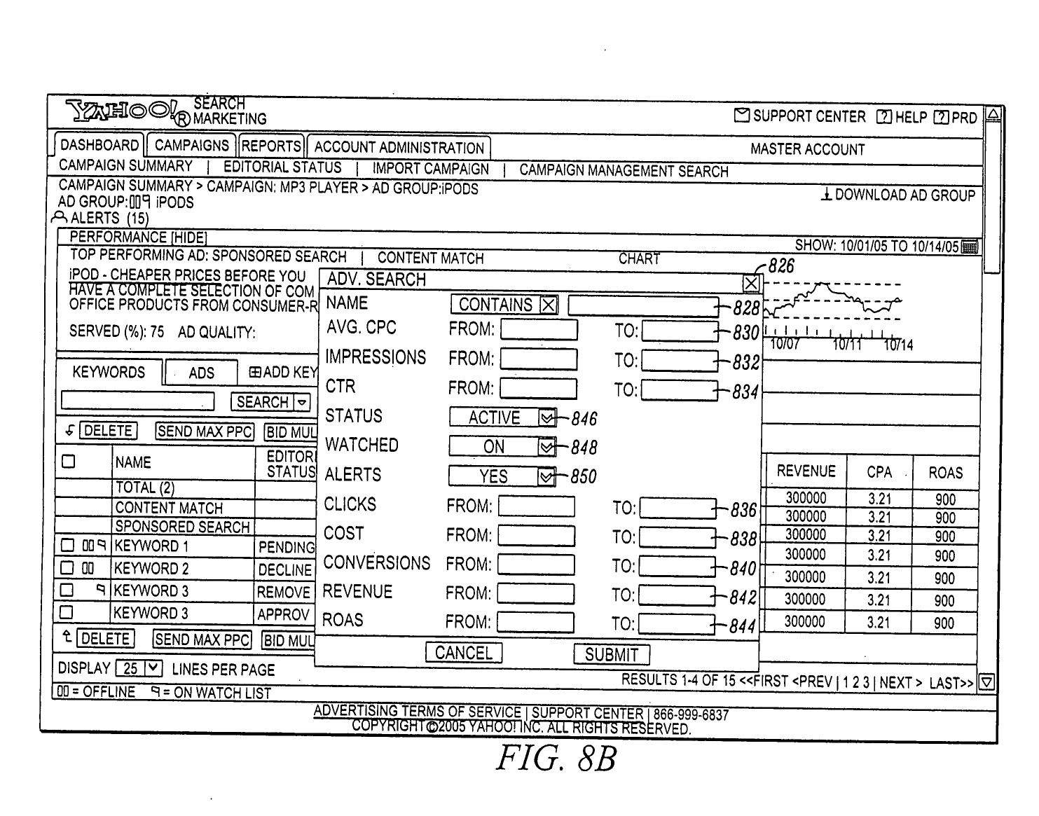

FIGS. 8a and 8b are examples of embodiments of graphical user interfaces for displaying and managing advertisement campaign information. Similar to the GUIs of FIGS. 6 and 7, the GUI 800a displays a summary of one or more ad campaigns 802 within an advertiser account. The GUI 800 may also comprise a search bar 804 that allows a user to search the summaries of the one or more ad campaigns 802. Using the search bar 804, a user may search for, and display, particular summaries of the one or more ad groups 802 based on performance parameters such as impressions 806, CTR 808, clicks 810, CPC 812, acquisitions 814, CPA 816, revenue 818, ROAS 820, amount spent on the ad campaign 822, or any other performance parameter provided by the advertisement service provider relating to an ad group. Further, the search bar 804 may allow a user to search for, and display, particular summaries that are greater than, less than, or equal to a value 824 input by the user.

FIG. 8b illustrates that in addition to, or in place of, a search bar 804 (FIG. 8a), a GUI may provide an advanced search GUI 826. The advanced search GUI 826 provides a user the ability to search for advertisements based on one or more search criteria. For example, the user may search for advertisements based on a range of values for one or more performance parameters associated with an advertisement or one or more ad campaign management settings of an advertisement.

In one embodiment, the advanced search GUI 826 provides the ability to search for advertisements that contain a piece of text or advertisements that do not contain a piece of text 828. Additionally, the advanced search GUI 826 provides the ability to search advertisements based on a range of values relating to performance parameters such as average CPC 830, impressions 832, CTR 834, clicks 836, cost 838, conversions 840, revenue 842, ROAS 844, or any other performance parameter associated with an advertisement that is provided by an advertisement campaign management system. Further, the advanced search GUI 826 provides the ability to search advertisements based on whether the advertisement is active 846, whether the advertisement is being watched 848, or whether there are alerts associated with the advertisement 850.

It will be appreciated that the advanced search GUI 826 provides the ability to search for advertisements based on any combination of one or more search criteria. For example, a user may conduct a first search for all advertisements having an average CPC 830 between $0.50 and $0.75. A user may also conduct a second search for all advertisements having an average CPC 830 between $0.50 and $0.75, a number of conversions 840 between 100 and 500, and whose status 846 is set to active.

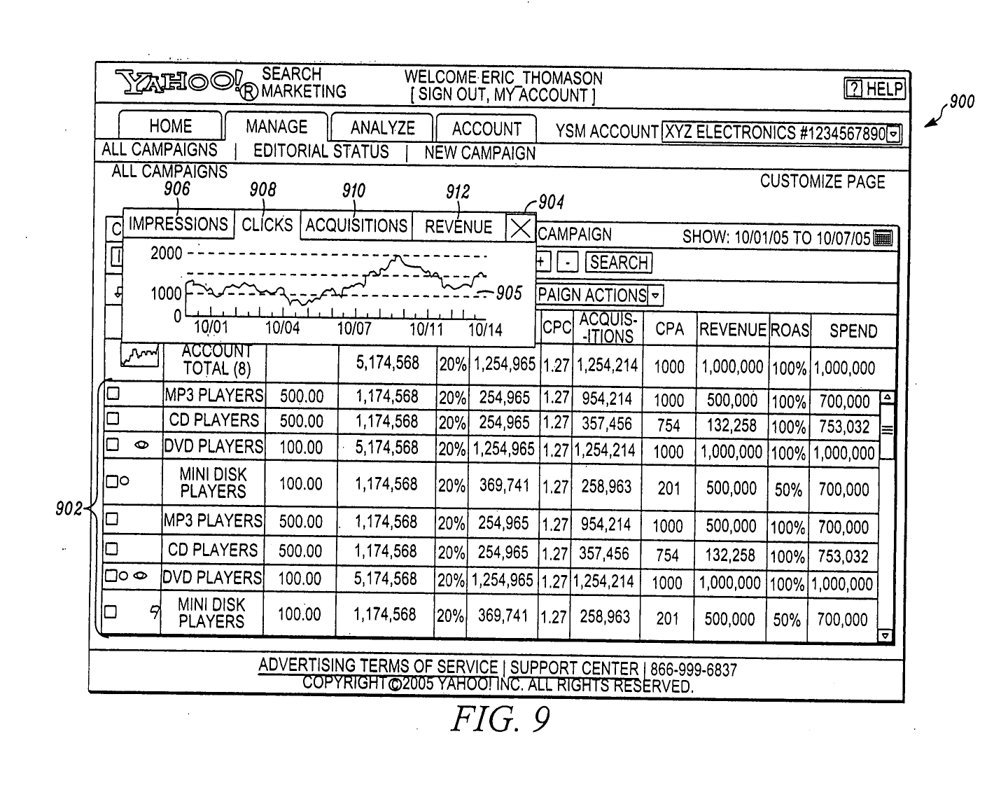

FIG. 9 is an example of another embodiment of a GUI for displaying and managing advertisement campaign information. Similar to the GUIs of FIGS. 6-8, the GUI 900 displays a summary of one or more ad campaigns 902 within an advertiser account. The GUI 900 may also comprise one or more hyperlinks, that when activated by a user, causes the advertisement campaign management system to create a secondary GUI 904. Typically, the secondary GUI 904 displays information such as performance parameters relating to an ad campaign in graphical form. In one embodiment, the secondary GUI 904 may comprise a graph 905 of performance parameters over a period of time related to an ad campaign such as impressions 906, clicks 908, acquisitions 910, revenue 912, or any other performance parameter provided by an advertisement service provider associated with an ad campaign.

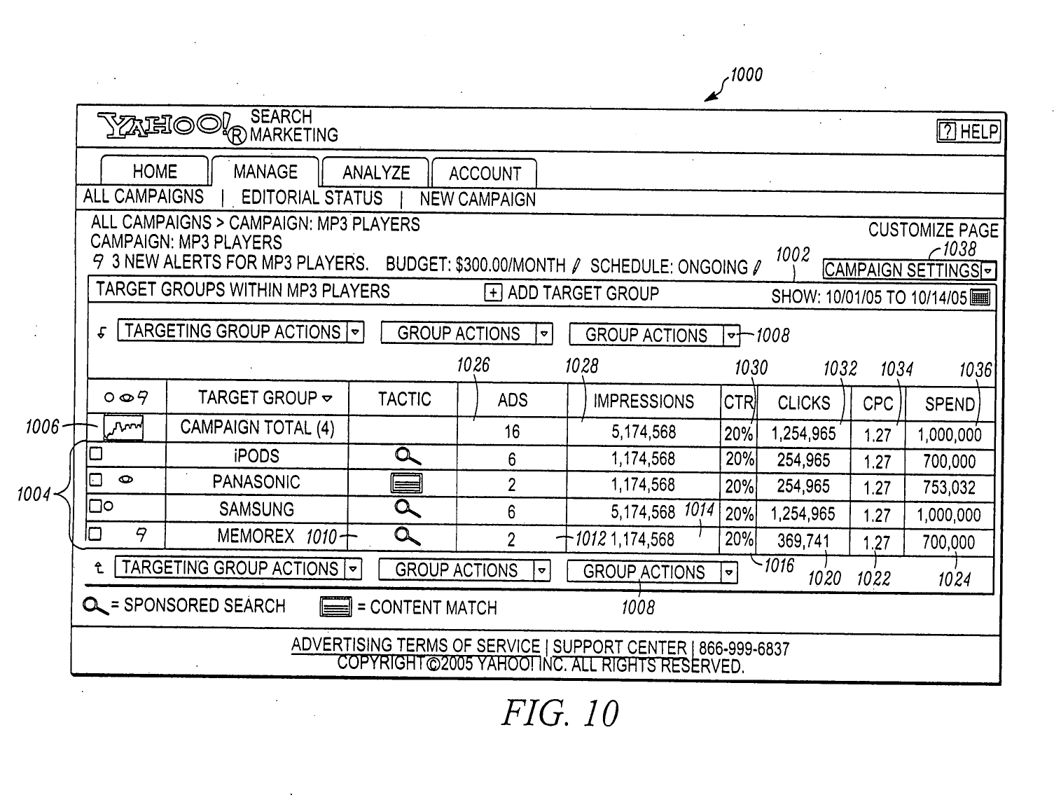

FIG. 10 is an example of one embodiment of a GUI for displaying and managing advertisement campaign information. Generally, the GUI 1000 comprises an ad group summary section 1002. The ad group summary section 1002 typically comprises one or more summaries of ad groups 1004 within a campaign, a summary bar 1006, and a plurality of ad group action hyperlinks 1008. Each summary of an ad group 1004 may comprise advertisement campaign information relating to the ad group such as a search tactic 1010, a number of advertisements within the ad group 1012, a number of impression 1014, a CTR 1016, a number of clicks 1020, a CPC 1022, an amount spent on an ad group 1024, or any other performance parameter provided by an advertisement service provider relating to an ad group. Similarly, the summary bar 1006 may comprise aggregate advertisement campaign information for all the ad groups within an ad campaign such as an aggregate number of ads 1026, an aggregate number of impressions 1028, an aggregate CTR 1030, an aggregate number of clicks 1032, an aggregate CPC for the for the ad groups within the ad campaign 1034, an aggregate amount spent for the ad groups within the ad campaign 1036, or any other performance parameter listed in the summary of an ad group 1004.

By selecting one or more ad groups within the ad group summary section 1002 and activating one of the ad group action hyperlinks 1008, a user may be able to perform an action such as pause an ad group, activate an ad group, delete an ad group, group multiple ad groups into one ad group, clone an ad group, move an ad group to a different ad campaign, add an ad group to a watch list, remove an ad group from a watch list, or any other function that can be performed on an ad group as a whole.

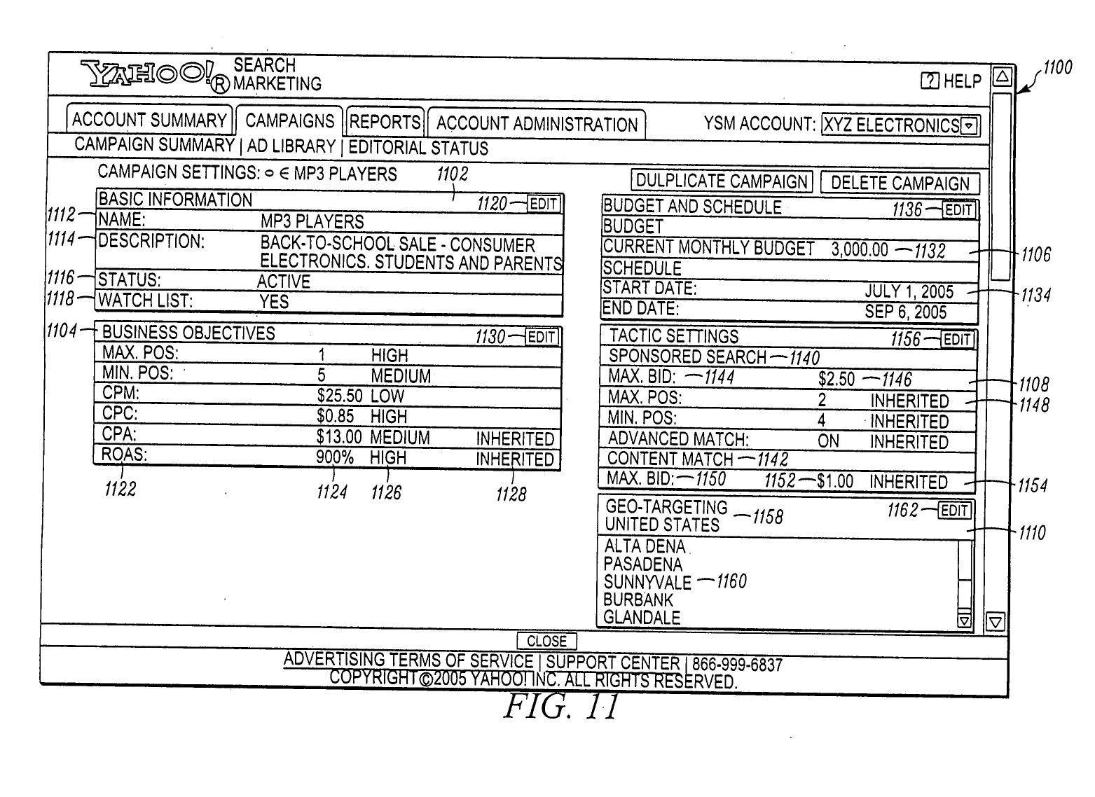

The GUI 1000 may additionally comprise a campaign setting hyperlink 1038 that when activated by a user opens one or more GUIs such as those in FIGS. 11-15. FIG. 11 is an example of one embodiment of a GUI for displaying and managing an advertisement campaign. Generally, in the illustrated embodiment, the GUI comprises a basic information section 1102, a business objective section 1104, a budget and schedule section 1106, a tactic setting section 1108, and a geo-targeting section 1110.

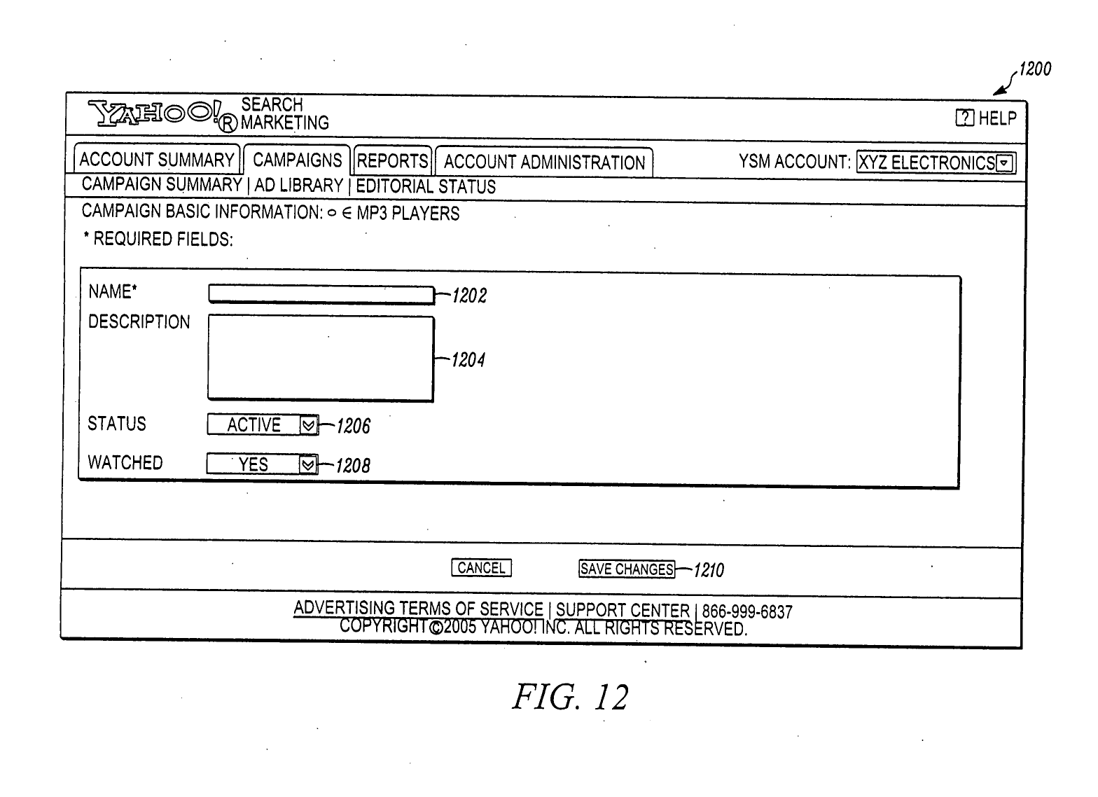

The basic information section 1102 may comprise information relating to an ad campaign such as a name of the ad campaign 1112, a description of the ad campaign 1114, a status indicator 1116, an indication of whether the ad campaign is on a watch list 1118, or any other set of information provided by an advertisement service provider related to an ad campaign. The basic information section 1102 may also comprise an edit hyperlink 1120 that when activated by the user allows that the user to edit any of the information listed in the basic information section 1102 as seen in FIG. 12 described below.

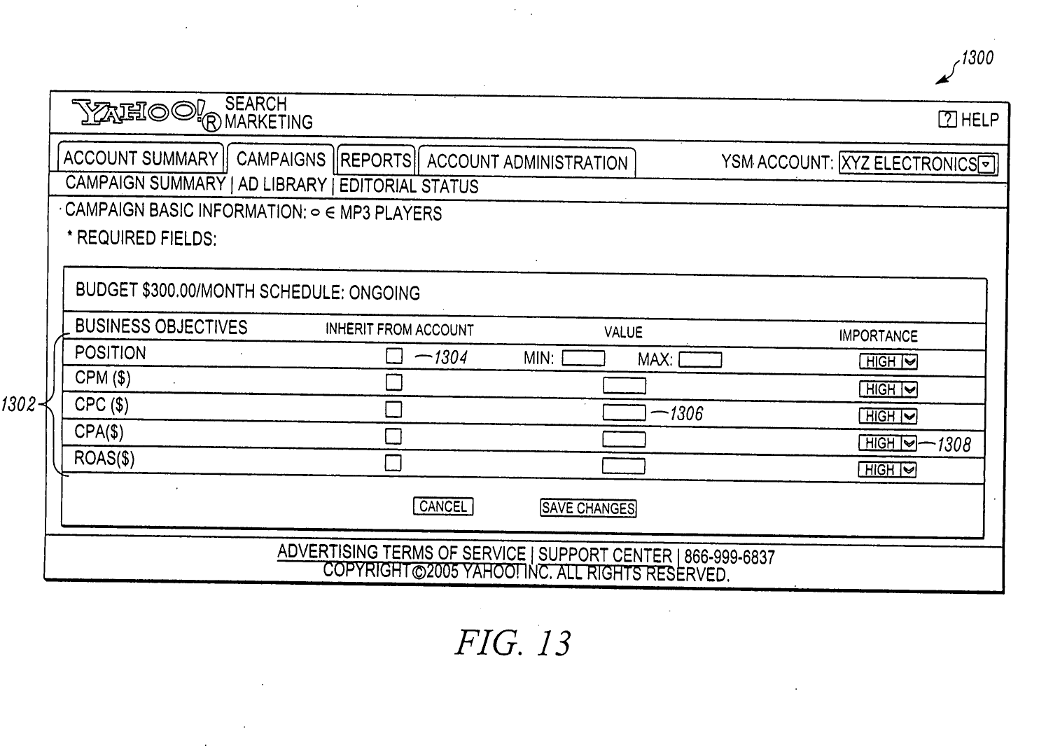

Referring again to FIG. 11, the business objective section 1104 gives an indication of results for respective business objectives. A business objective may be a performance goal for one of the parameters specified in FIG. 11, or another goal for the advisement campaign. The business objective section 1104 may comprise a listing of one or more performance parameters 1122, a current value associated with each performance parameter 1124, a designation of the importance of each performance parameter 1126, and an indication of whether the values associated with each performance parameter is inherited 1128. In one embodiment, a value of a performance parameter may be inherited if the value was obtained from an associated account level. For example, an ad campaign may inherit a value of a performance parameter from an advertiser account level setting that is propagated through all ad campaigns within the advertiser account. Alternatively, ad group may inherit a value of a performance parameter from an advertiser ad campaign level setting that is propagated through all ad campaigns within an ad group. The business objective section 1104 may also comprise an edit hyperlink 1130 that that when activated by the user allows the user to edit any of the business objective settings associated with the one or more performance parameters 1124 as seen in FIG. 13 described below.

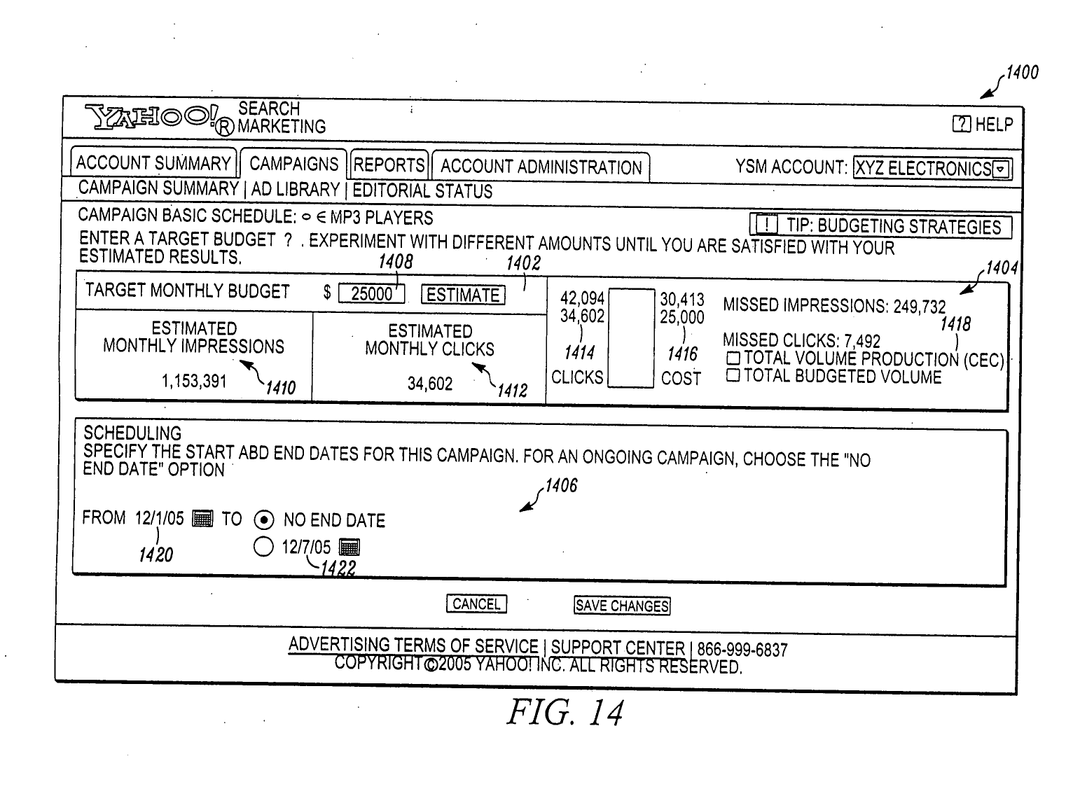

Referring again to FIG. 11, the budget and schedule section 1106 may comprise advertisement campaign information such as a current monthly budget 1132 for an ad campaign, and a start and end date 1134 for the ad campaign. The budget and schedule section 1106 may additionally comprise an edit hyperlink 1136 that when activated by the user allows the user to modify a budget, or a start and end date of an ad campaign associated with an ad campaign as seen in FIG. 14 described below.

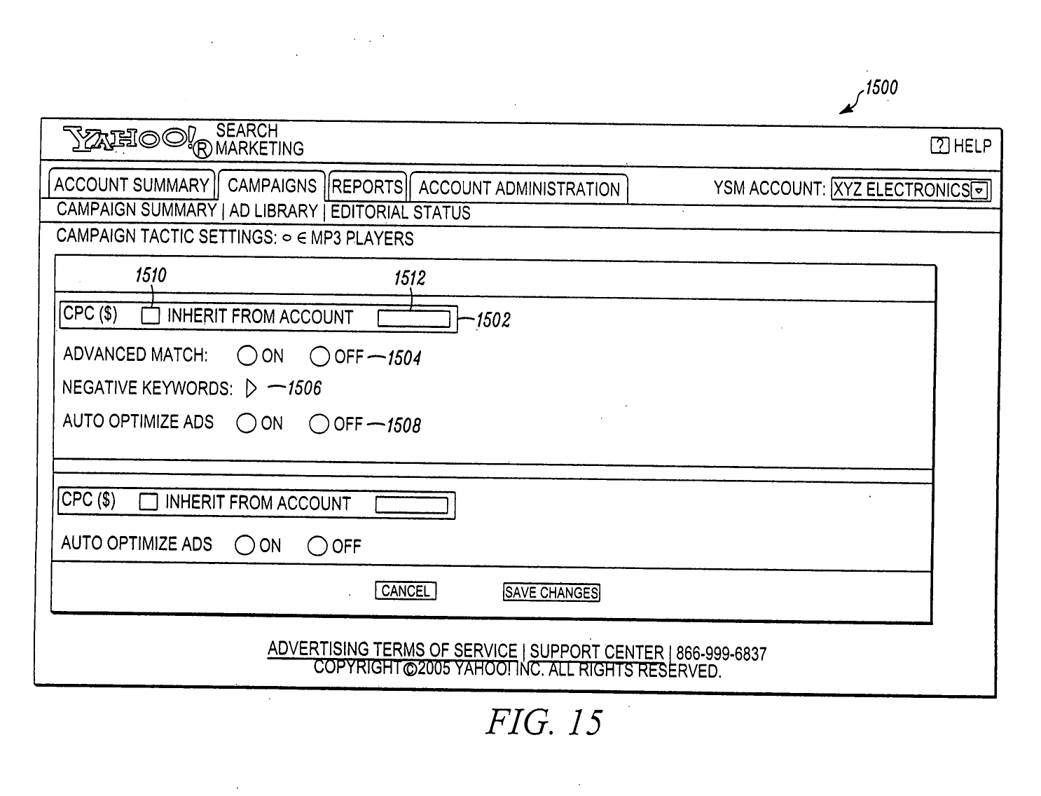

Referring again to FIG. 11, the tactic setting section 1108 may comprise a sponsored search section 1140, a content match section 1142, or a section for any other type of search tactic known in the art. Generally, the sponsored search section 1140 may comprise one or more performance parameters 1144 associated with sponsored search, a current value of each performance parameter 1146, and an indication whether the value of each performance parameter is inherited 1148. Similarly, the content match section 1142 may comprise one or more performance parameters 1150 associated with content match, a current value of each performance parameter 1152, and an indication whether the value of each performance parameter is inherited 1154. The tactic setting section 1108 may also comprise an edit hyperlink 1156 that when activated by the user allows the user to modify the tactic settings associated with an ad campaign as seen in FIG. 15 described below.

Referring again to FIG. 11, the geo-targeting section 1110 may comprise a listing of the names of countries 1158, cities 1160, or regions that an ad campaign is directed to. The geo-targeting section 1110 may also comprise an edit hyperlink 1162 that when activated by the user allows the user to modify the geo-target settings associated with an ad campaign.

It will be appreciated that all of the advertisement campaign information displayed in GUI 1100 with respect to an ad campaign may also be displayed in a GUI with respect to an ad group.

FIG. 12 is an example of one embodiment of a GUI for editing basic information relating to an advertisement campaign. However, it will be appreciated that a similar GUI may be created for editing basic information relating to an ad group. Generally, the GUI 1200 comprises a window 1202 for editing a name of the advertisement campaign, a window 1204 for editing a description of the advertisement campaign, a drop-down menu 1206 for changing the status of the advertisement campaign, a drop-down menu 1208 for changing whether the advertisement campaign management system is to watch the advertisement campaign, and a save changes hyperlink 1210 to save the current information within windows 1202 and 1204, and drop-down menus 1206 and 1208.

FIG. 13 is an example of one embodiment of a GUI for displaying and managing business objectives at an ad campaign level. However, it will be appreciated that that a similar GUI may be created for displaying and managing business objectives at an ad group level. Generally, the GUI 1300 comprises listings for one or more business objectives 1302. For each business objective, a user may modify different parameters associated with the business objective. For example, a user may choose whether a business objective is inherited 1304 from a different advertiser account level as described above. A user may also input values for performance parameters associated with the ad campaign 1306 such as minimum and maximum position in a search listing, CPM, CPC, CPA, or ROAS if the value of the performance parameter is not inherited. Further, a user may also choose a level of importance 1308 for the business objective such as not important, important, or high importance for use with the campaign optimizer 175 (FIG. 1).

FIG. 14 is an example of one embodiment of a GUI for displaying and managing budget and scheduling parameters at an ad campaign level. However, it will be appreciated that a similar GUI may be created for displaying and managing budget and scheduling parameters at an ad group level. Generally, the GUI 1400 comprises an estimate tool 1402, an estimate graph 1404, and a scheduling tool 1406.

The estimate tool 1402 allows a user to input values 1408 such as a target monthly budget and to dynamically create estimated performance parameters such as an estimated number of monthly impressions 1410 or an estimated number of monthly clicks 1412 based on the value input for a target monthly budget.

The estimate graph 1404 may comprise an illustration of a potential number of clicks vs. a current estimated number of clicks 1414 and an illustration of a budget necessary to obtain the potential number of clicks vs. a current target monthly budget 1416. Additionally, the estimate graph 1404 may comprise numerical listings 1418 of a number of impressions and clicks that are missed with the current target monthly budget. In one embodiment, the illustrations 1414, 1416 and numerical listings 1418 are dynamically updated when the user enters a new value in the estimate tool 1402 and dynamically creates estimated performance parameters. In one embodiment, the data necessary to calculate the potential number of clicks, current estimated number of clicks, budget necessary to obtain the potential number of clicks, and number of impressions and clicks that are missed with the current monthly budget is obtained from the campaign optimizer 175 (FIG. 1) and forecast component 185 (FIG. 1) described above.

The scheduling tool 1406 allows a user to set a beginning date and an end date for an ad campaign. Typically, the scheduling tool 1406 comprises a starting date 1420 window where a user can select a current date or a date in the future to start an ad campaign, and an ending date window 1422 wherein a user may select a date in the future to end the campaign or choose to not have an ending date for the campaign.

FIG. 15 is an example of one embodiment of a GUI for editing advertisement campaign tactic settings relating to an advertisement campaign. However, it will be appreciated that a similar GUI may be created for editing campaign tactic settings relating to an ad group. Generally, the GUI 1500 comprises a CPC selection area 1502, an advance match selection area 1504, a listing of any negative keywords 1506, and an auto optimize selection area 1508.

The CPC selection area 1502 allows a user to set the CPC for the advertisement campaign. In one embodiment, the user may choose to inherit a CPC from an account level by selecting an area 1510 within the CPC selection area 1502. Alternatively, a user may enter a CPC to use for the advertisement campaign in a designated window 1512.

The advance match selection area 1504 allows a user to select whether advance match is turned on or off within the advertisement campaign management system. When advance match is turned on, the advertisement service provider implements advanced matching algorithms rather than exact-phrase matching algorithms so that the advertisement service provider serves an advertisement more often. The listing of negative keywords 1506 are terms used when the advance match is turned on to avoid finding a match for an advertisement for certain meanings of a word when a keyword has multiple meanings.

Finally, the auto optimize selection area 1508 allows a user to select whether to allow the advertisement campaign management system to adjust one or more performance parameters of an advertisement campaign to optimize performance of the advertisement campaign based on one or more business objectives of a user.

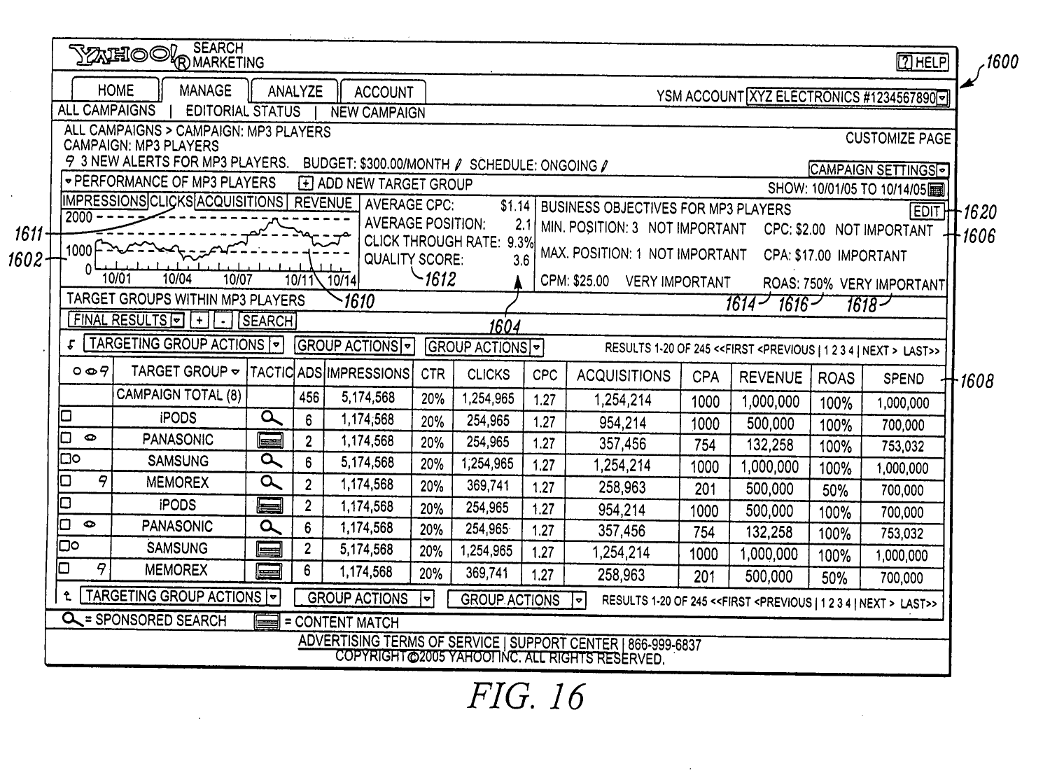

FIG. 16 is an example of another embodiment of a GUI for displaying and managing advertisement campaign information. Generally, the GUI 1600 of FIG. 16 comprises an ad campaign graph section 1602, an ad campaign summary section 1604, an ad campaign management section 1606, and an ad group summary section 1608 similar to the ad group summary section described above with respect to the GUI 1000 of FIG. 10.

The ad campaign graph section 1602 typically comprises a graph 1610 illustrating a selected performance parameter 1611 of the ad campaign over a period of time. For example, the graph 1610 may illustrate a number of impressions of advertisements within a campaign, a number of clicks, a number of acquisitions, revenue, or any other performance parameter associated with an ad campaign provided by the advertisement service provider.

The ad campaign summary section 1604 typically comprises one or more average performance parameters 1612 for all ad groups within an ad campaign. For example, the average performance parameters 1612 may comprise an average CPC, an average position in a search listing, an average click-through rate, a quality score for the overall campaign, or any other performance parameter associated with an ad campaign provided by the advertisement service provider than can averaged over all ad groups within an ad campaign.

The ad campaign management section 1606 typically comprises one or more performance parameters 1614 associated with an ad campaign, a current value 1616 associated with each performance parameter 1614, and a current designation of the importance 1618 of each performance parameter 1614. The one or more performance parameters 1614 relating to an ad campaign may comprise a minimum allowable position in a search listing, a maximum allowable position in a search listing, CPM, CPC, CPA, ROAS, or any other performance parameter provided by an internet service provider.

Further, the GUI 1600 may comprise an edit hyperlink 1620 that when activated by a user, takes the user to a GUI such as in FIG. 13 to allow the user to modify the business objectives associated with an ad campaign.

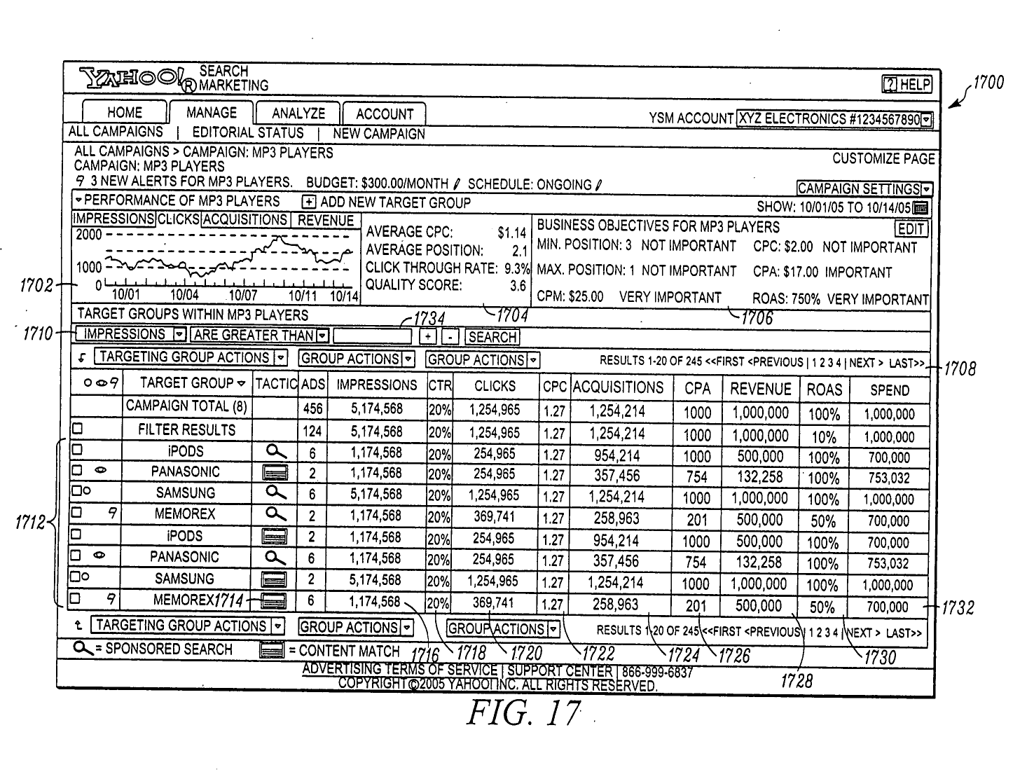

FIG. 17 is an example of another embodiment of a GUI for displaying and managing advertisement campaign information. Generally, the GUI 1700 comprises an ad campaign graph section 1702, an ad campaign summary section 1704, an ad campaign management section 1706, and an ad group summary section 1708 similar to the GUI 1600 of FIG. 16. However, the GUI 1700 of FIG. 17 also comprises a search bar 1710 that allows a user to search for, and display, summaries of one or more ad groups 1712 associated with an ad campaign. Using the search bar 1710, a user may search for summaries of the one or more ad groups 1712 based on a search tactic 1714, impressions 1716, CTR 1718, clicks 1720, CPC 1722, acquisitions 1724, CPA 1726, revenue 1728, ROAS 1730, an amount spent on the ad group 1732, or any other performance parameter provided by the advertisement service provider relating to an ad group. Further, the search bar 1710 may allow a user to search for summaries that are greater than, less than, or equal to a value 1734 input by the user.

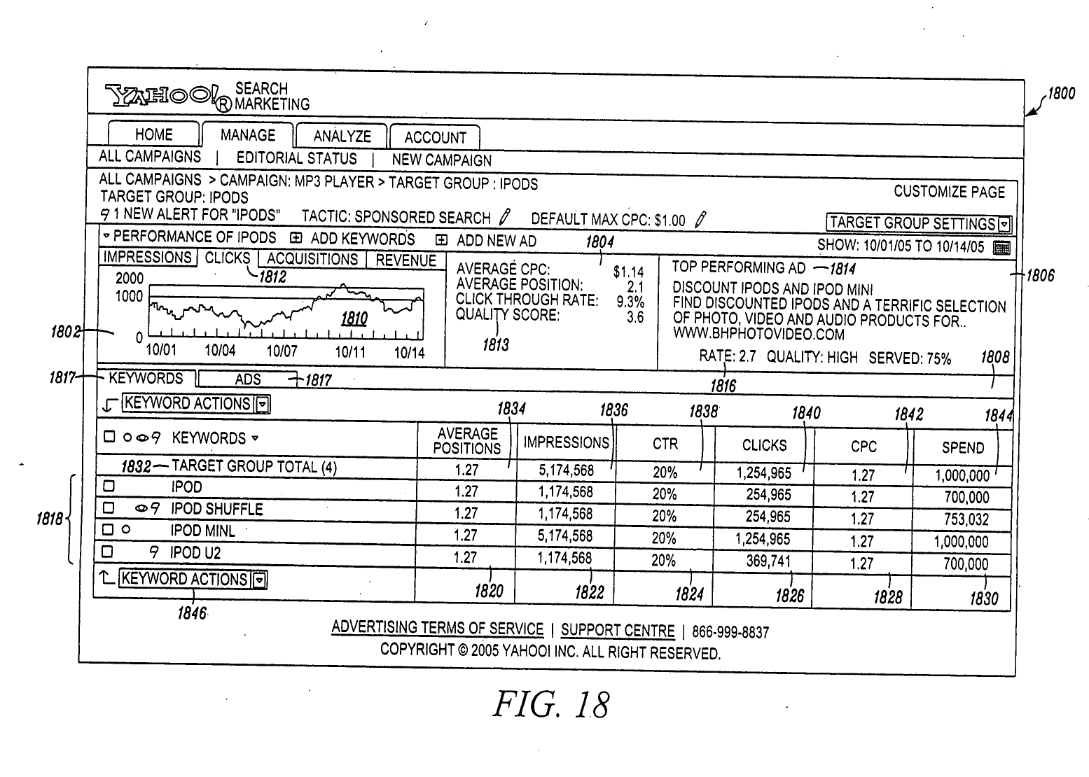

FIG. 18 is an example of another embodiment of a GUI for displaying and managing advertisement campaign information. Generally, the GUI 1800 of FIG. 18 may comprise an ad group graph section 1802, an ad group summary section 1804, an ad group top performing ad section 1806, and a keyword/advertisement summary section 1808.

The ad group graph section 1802 typically comprises a graph 1810 illustrating a selected performance parameter 1812 of an ad group over a period of time. For example, the graph 1810 may illustrate a number of impressions of advertisements within an ad group, a number of clicks, a number of acquisitions, revenue, or any other performance parameter associated with an ad group provided by the advertisement service provider.

The ad group summary section 1804 typically comprises one or more average performance parameters 1813 for all advertisements within an ad group. For example, the average performance parameters 1813 may comprise an average CPC, an average position in a search listing, an average click-through rate, a quality score for the overall ad group, or any other performance parameter associated with an ad group provided by the advertisement service provider than can averaged over all advertisements within an ad group.

The ad group top performing ad section 1806 may comprise an advertisement 1814 and one or more performance parameters 1816 associated with the advertisement 1814. A top performing advertisement within an ad group may be an advertisement having a highest performance parameter within the ad group as defined by the advertiser or advertiser service provider, such as the advertisement with the highest number of impressions, highest CTR, or the largest number of clicks.

The one or more performance parameters 1816 associated with the advertisement 1814 may comprise a click-through rate of the advertisement, a quality of the advertisement, a percentage of an advertisement served in relation to all advertisements in the ad group, or any other performance parameter associated with a top performing advertisement provided by an advertisement service provider.

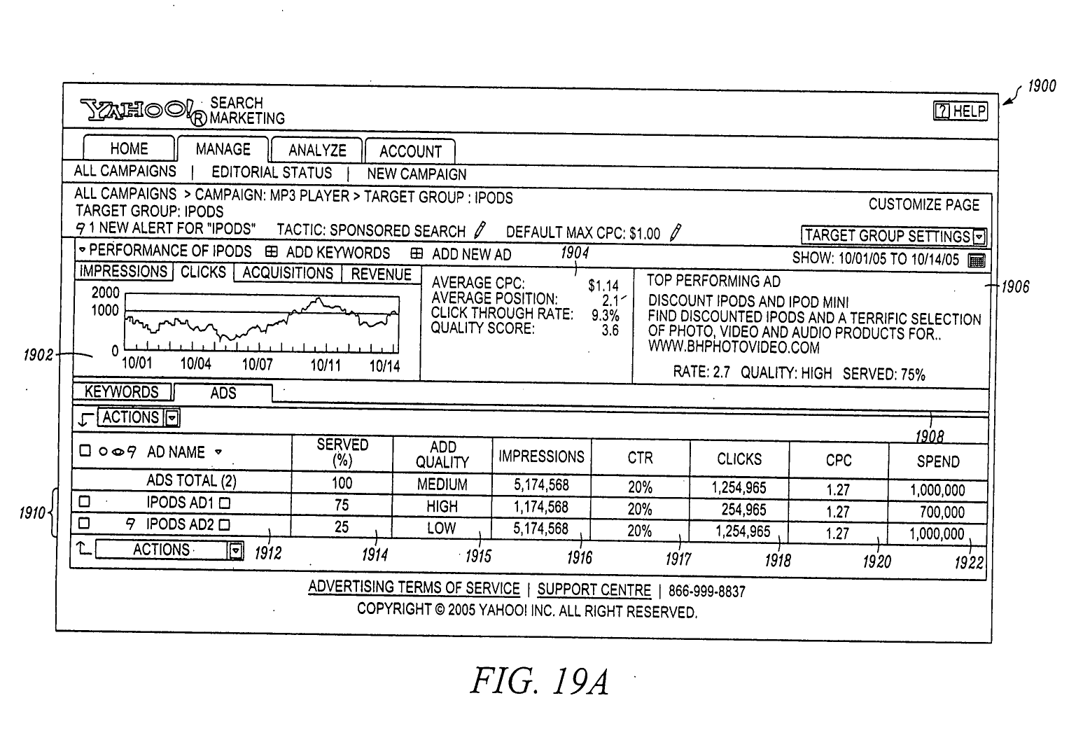

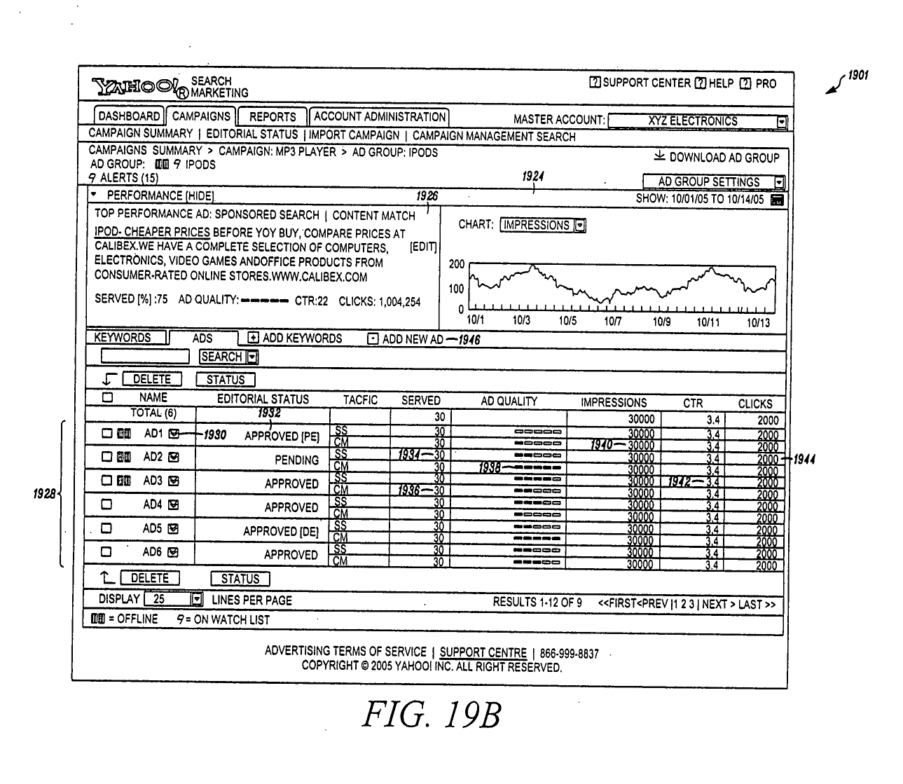

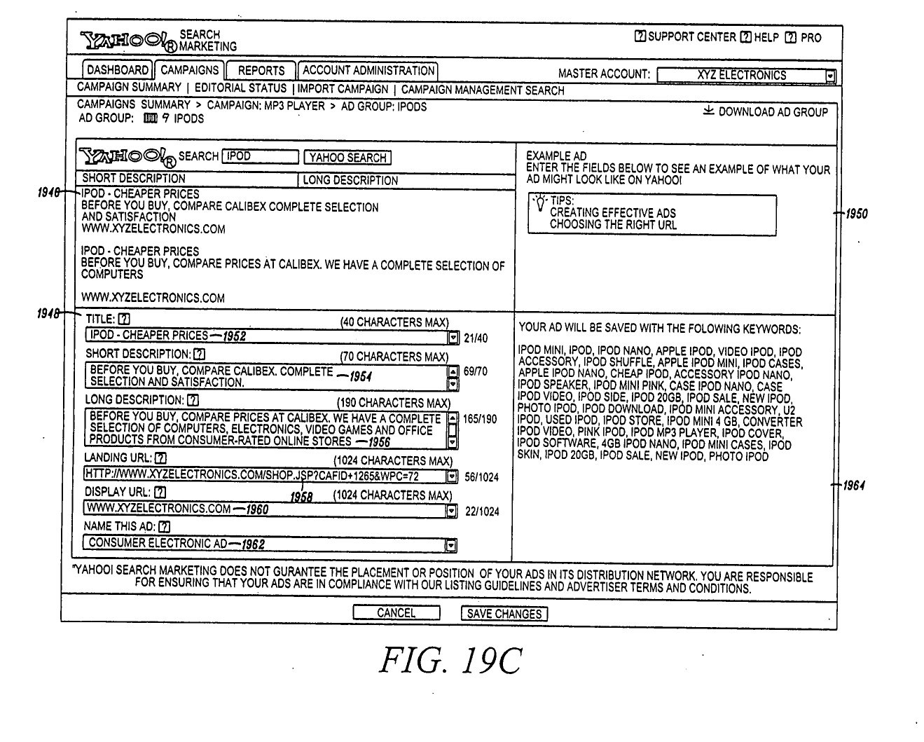

The keyword/advertisement summary section 1808 comprises at least two tabs 1817 to allow a user to view advertisement campaign information relating to an ad group with respect to keywords or advertisements. In FIG. 18, advertisement campaign information relating to an ad group is displayed in terms of keywords where in FIG. 19 (described below), advertisement campaign information relating to an ad group is displayed in terms of advertisements. Referring to FIG. 18, the keyword/advertisement summary section 1808 comprises one or more summaries of the keywords within the ad group 1818. Each summary 1818 may comprise an average position in a search listing of advertisements in the ad group related to the keyword 1820, the number of impressions of advertisements in the ad group related to the keyword 1822, a CTR of advertisements in the ad group related to the keyword 1824, the number of clicks of advertisements in the ad group related to the keyword 1826, a CPC of advertisements in the ad group related to the keyword 1828, an amount spent on advertisements in the ad group relating to the keyword 1830, or any other performance parameter provided by the advertisement service provider relating to a keyword of an ad group.

The keyword/advertisement section 1808 may also comprise a summary bar 1832. The summary bar 1832 may comprise advertisement campaign information for all keywords in the ad group or all the keywords currently displayed in the keyword/advertisement section 1808. For example, the summary bar 1832 may comprise an average position of advertisements of the ad group associated with particular keywords 1834, an aggregate number of impressions 1836, an average CTR 1838, an aggregate number of clicks 1840, an average CPC 1842, an aggregate amount spent on advertisements of the ad group associated with particular keywords 1844, or an aggregate of any other performance parameter listed in the summaries of the keywords within an ad group 1818.

The GUI 1800 may also comprise one or more keyword action hyperlinks 1846. Similar to the ad campaign and ad group action hyperlinks described above, a user may select one or more keywords and activate the one or more keyword action hyperlinks to perform actions such as pause a keyword, activate a keyword, delete a keyword, move a keyword to a different ad group, clone a keyword, add a keyword to a watch list, remove a keyword from a watch list, or any other functions that can be performed on keywords.

FIGS. 19a, 19b, and 19c are examples of embodiments of GUIs for displaying and managing advertisement campaign information. Similar to FIG. 15, the GUI 1900 of FIG. 19a may comprise an ad group graph section 1902, an ad group summary section 1904, an ad group top performing ad section 1906, and a keyword/advertisement summary section 1908. The keyword/advertisement summary section 1908 displays advertisement campaign information relating to an ad group in terms of advertisements. Generally, the keyword/advertisement summary section 1908 comprises one or more summaries 1910 of advertisement campaign information associated with a particular advertisement. The summary 1910 may comprise a name of the advertisement 1912, a percentage of an advertisement served in relation to all advertisements in the ad group 1914, a quality of an advertisement 1915, a number of impressions of an advertisement 1916, a CTR of an advertisement 1917, a number of clicks on an advertisement 1918, a CPC of an advertisement 1920, an amount spent on an advertisement 1922, or another performance parameter supplied by an advertisement service provider relating to an advertisement.

FIG. 19b is another embodiment of a GUI for displaying and managing advertisement campaign information. The GUI 1901 of FIG. 19b may comprise an ad group graph section 1924, an ad group top performing ad section 1926, and a keyword/advertisement summary section 1928. Generally, the keyword/advertisement section 1928 comprises one or more advertisement summaries 1930. Each advertisement summary 1930 may include ad campaign information associated with an advertisement such as an indication of whether the advertisement has been approved 1932, a number of times an advertisement service provider has served the advertisement using sponsored search 1934, a number of times an advertisement search provider has served an advertisement based on content match 1936, a graphical representation of a quality of an advertisement 1938, or performance parameters associated with an advertisement such as a number of impressions 1940, a CTR 1942, a number of clicks 1944, or any other performance parameter provided by an ad campaign management system.

FIG. 19c is another embodiment of a GUI 1903 for creating an advertisement. In one embodiment, the GUI 1903 is displayed after activating a hyperlink such as hyperlink 1942 of GUI 1901 (FIG. 19b). Generally, the GUI 1903 includes an advertisement preview area 1946, an advertisement creation area 1948, and an advertisement creation help area 1950.

The advertisement creation area 1948 may include one or more fields that provide the user with the ability to create an advertisement and preview the advertisement in the advertisement preview area 1946. The fields in the advertisement creation area 1948 may include fields to insert a title 1952, short description 1954, long description 1956, landing URL 1958, display URL 1960, or name 1962 of an advertisement. As text is inserted in any of the fields described above, the ad campaign management system dynamically creates a preview of the advertisement in the advertisement preview area 1946. The advertisement creation area 1948 may additionally include a keyword listing area 1964 that lists keywords associated with the advertisement being created.

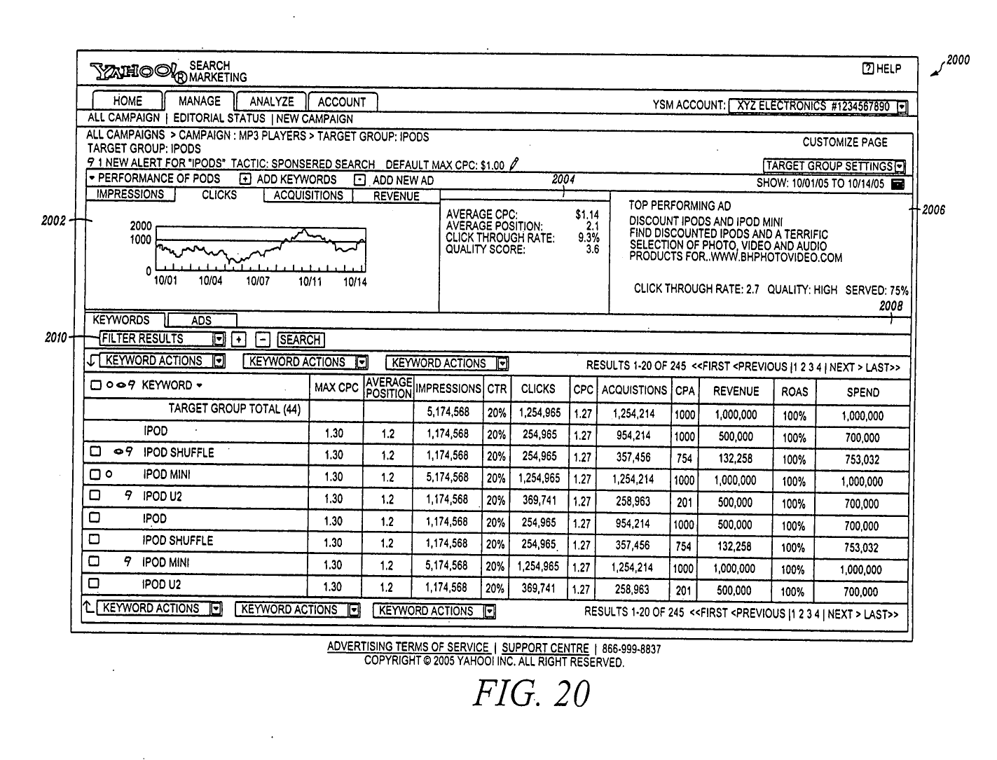

FIG. 20 is an example of another embodiment of a GUI for displaying and managing advertisement campaign information. Similar to FIGS. 18 and 19a, the GUI 2000 of FIG. 20 may comprise an ad group graph section 2002, an ad group summary section 2004, an ad group top performing ad section 2006, and a keyword/advertisement summary section 2008. The GUI 2000 may also comprise a filter bar 2010 to allow a user to filter the keyword summaries of an ad group according to a performance parameter or any other advertisement campaign information associated with the ad group.

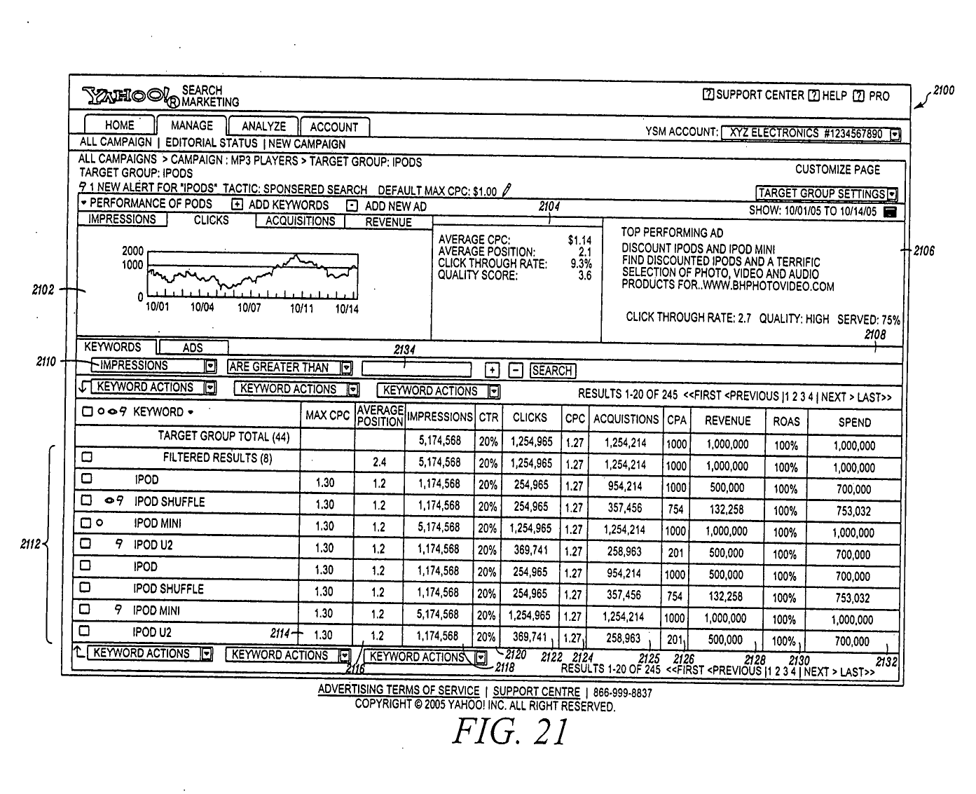

FIG. 21 is an example of another embodiment of a GUI for displaying and managing advertisement campaign information. Similar to FIGS. 18-20, the GUI 2100 of FIG. 21 may comprise an ad group graph section 2102, an ad group summary section 2104, an ad group top performing ad section 2106, and a keyword/advertisement summary section 2108. The GUI 2100 may also comprise a search bar 2110 that allows a user to search the one or more keyword summaries 2112 based on maximum CPC 2114, average position 2116, impressions 2118, CTR 2120, Clicks 2122, CPC 2124, acquisitions 2125, CPA 2126, revenue 2128, ROAS 2130, amount spent 2132, or any other performance parameter related to a keyword of the ad group that is provided by the advertisement service provider. Further, the search bar 2110 may allow a user to search the one or more keyword summaries 2112 that are greater than, less than, or equal to a value 2134 input by the user.

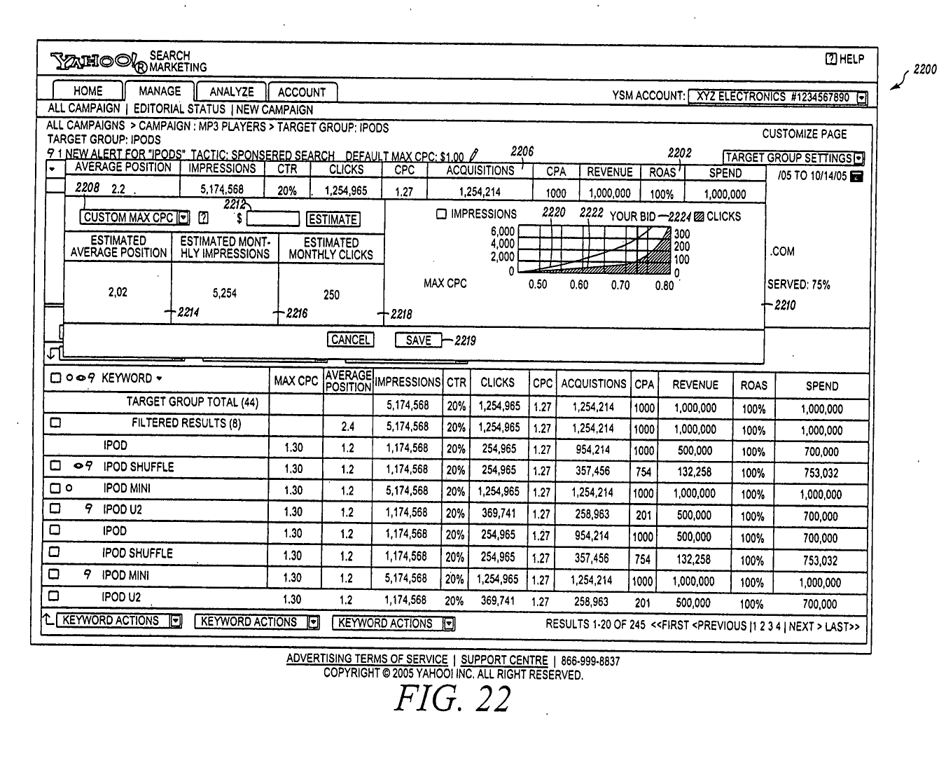

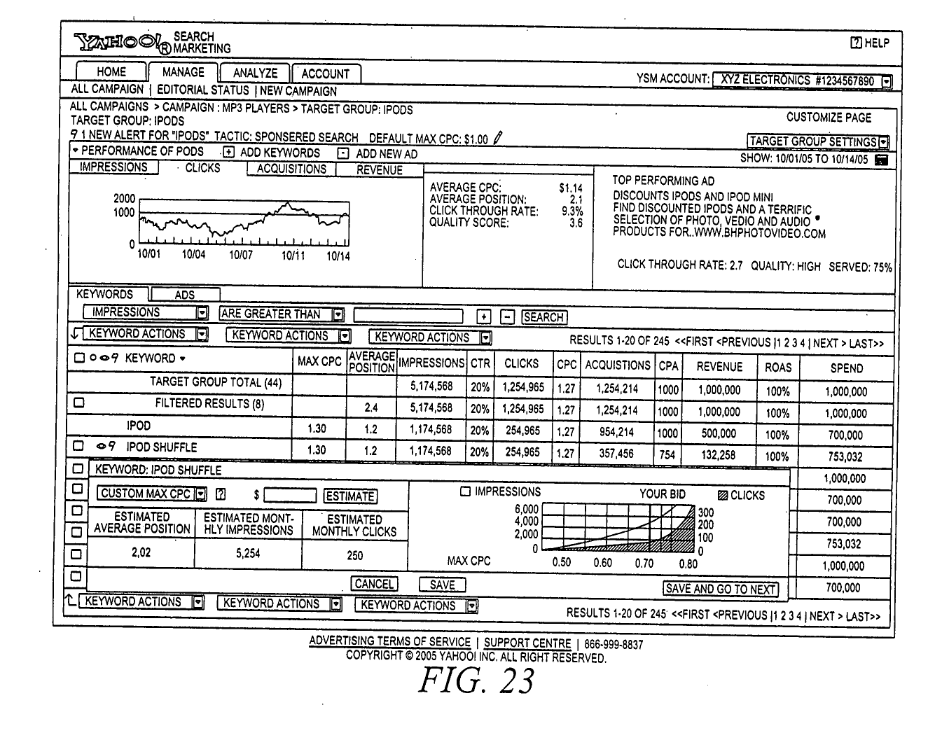

FIGS. 22 and 23 are examples of additional embodiment of GUIs for displaying and managing advertisement campaign information. As seen in FIG. 22, a secondary management GUI 2202 may be dynamically created by activation of a hyperlink on the primary GUI. The secondary management GUI 2202 may comprise a listing of performance parameters 2206 such as average position, impressions, CTR, clicks, acquisitions, CPA, revenue, ROAS, spend, or any other performance parameter provided by the advertisement service provider. Further, the secondary management GUI 2202 may comprise an estimate tool 2208 and an estimate graph 2210. The estimate tool 2208 allows a user to input potential performance parameter values 2212 such as a potential value of a maximum CPC and dynamically create other estimated performance parameters for an ad group based on the value of the potential performance parameter such as an estimated average position 2214, an estimated monthly impression 2216, or a number of estimated monthly clicks 2218. If at any point a user wishes to save the value of the potential performance parameter input 2212 to the estimate tool 2208 as a new value assigned to the appropriate performance parameter, a user may execute the save 2219 button.

In one embodiment, the estimate graph 2210 comprises an illustration of an estimated number of impressions 2220 and an estimated number of clicks 2222 versus a maximum CPC setting (a bid), and a current bid estimate indicator 2224. Typically, the estimated number of impressions 2220 and the estimated number of clicks 2222 are a function of the current performance parameter settings of the ad group. The current bid estimate indicator 2224 illustrates where the current bid of the user is located in relation to the estimated number of impressions 2220 and the estimated number of clicks 2222. As a user creates new estimated performance parameters for an ad group using the estimate tool 2208, the current bid estimate indicator 2224 shifts in relation to the estimated number of impressions 2220 and the estimated number of clicks 2222 according to the estimated performance parameters.

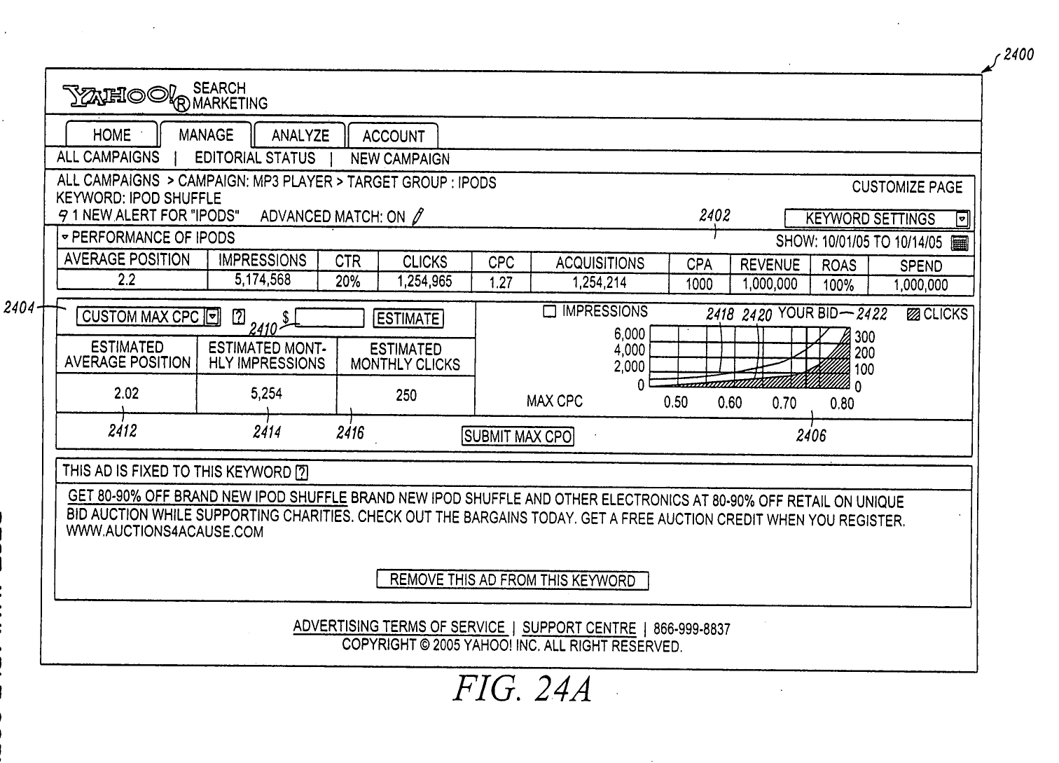

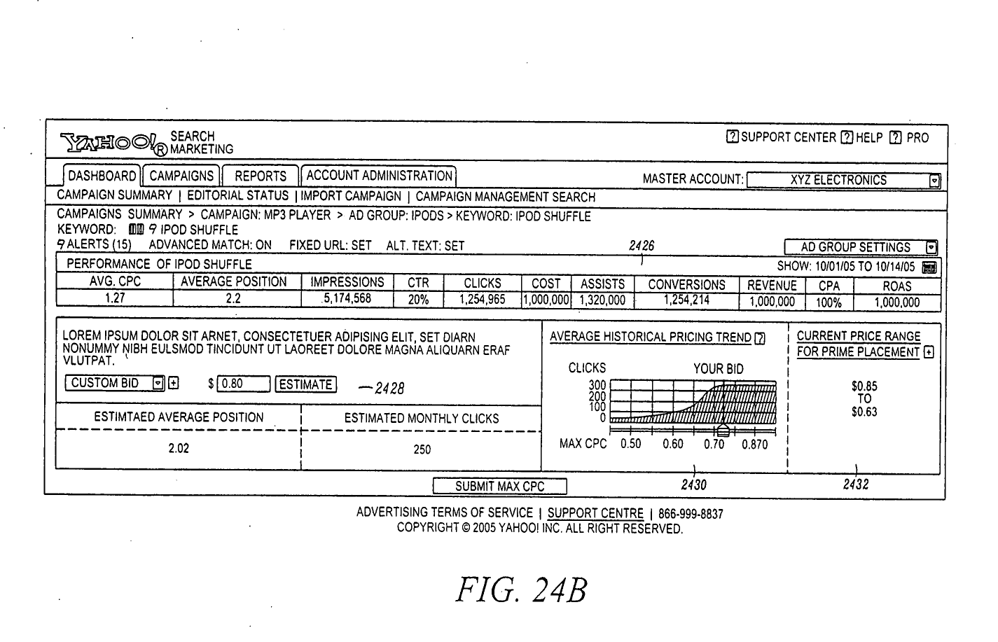

FIGS. 24a and 24b are examples of additional embodiments of GUIs for displaying, managing, and optimizing advertisement campaign information. Generally, the GUI 2400 of FIG. 24a allows a user to set various performance parameters for keywords within an ad group. Generally, the GUI 2400 may comprise a performance section 2402, an estimate tool 2404, an estimate graph 2406, and a preview section 2408. The performance section 2402 may comprise one or more numerical listings of performance parameters associated with a keyword of the ad group such as an average position, number of impressions, CTR, Clicks, CPC, acquisitions, CPA, revenue, ROAS, amount spent, or any other performance parameter provided by an advertisement service provider that relates to a keyword of the ad group.

The estimate tool 2404 allows a user to input potential performance parameters values 2410 such as a potential value of a maximum CPC and dynamically create estimated performance parameters for a keyword of an ad group based on the value of the potential performance parameter such as an estimated average position 2412, an estimated monthly impression 2414, or a number of estimated monthly clicks 2416.

In one embodiment, the estimate graph 2406 comprises an illustration of an estimated number of impressions 2418 and an estimated number of clicks 2420 versus a maximum CPC setting, and a current bid estimate indicator 2422. The current bid estimate indicator 2422 illustrates where the current bid of the user is located in relation to the estimated number of impressions 2418 and the estimated number of clicks 2420. As a user creates new estimated performance parameter values for a keyword of an ad group using the estimate tool 2404, the current bid estimate indicator 2422 shifts in relation to the estimated number of impressions 2418 and the estimated number of clicks 2420 according to the estimated performance parameters.

The preview section 2408 displays one or more advertisements that are fixed to a keyword. Typically, the preview section 2408 provides a user with the ability to perform one or more actions 2424 on an advertisement displayed in the preview section, such as providing the ability to remove an advertisement from a keyword.

FIG. 24b is an example of another embodiment of a GUI 2401 for allowing a user to set various performance parameters for keywords within an ad group. Similar to the GUI 2400 of FIG. 24a, GUI 2401 may include a performance section 2426, an estimate tool 2428, and an estimate graph 2430 as described above. The GUI 2401 may additionally include a prime placement suggestion area 2432. The prime placement suggestion area 2432 provides a recommendation including a range of values to an advertiser that should result in an advertisement obtaining a premium position in search results. Examples of a premium position include a prominent position in the search results such as near the beginning of a web page or a position on a first page of search results. In one embodiment, the recommendation in the prime placement suggestion area 2432 is calculated based on current performance parameters such as those listed in the performance section 2426 and forecasts obtained from the forecast component 185 (FIG. 1) described above.

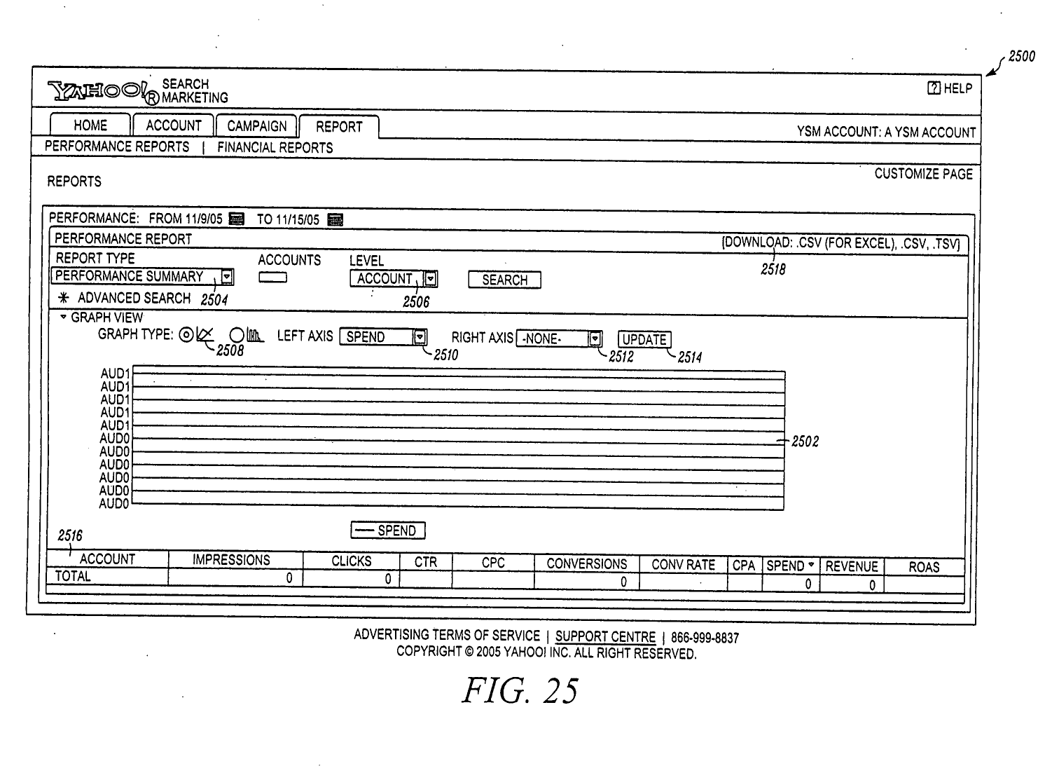

FIGS. 25-31 are different embodiments of GUIs for displaying and customizing reports comprising advertisement campaign information. As described above with respect to FIG. 1, the campaign management system provides the ability to receive advertisement campaign information from various sources including the channel server 150, pod collection server 135 and third-party analytics feeds component 180. The BIG component 155 of the campaign management system assures that this data is received in a correct and timely manner, and may also perform aggregation and filtering on raw data impressions that are coming into the pod 100. After the received data is filtered and received, the campaign management system may generate reports regarding all advertisement campaign information related to a single advertiser account from a plurality of advertisement service providers.

Referring to FIGS. 25-31, typically the GUIs 2500 may comprise a graph section 2502, a menu for choosing a report type 2504, a drop down menu for choosing at what account level to view the report 2506, one or more activation areas for choosing between types of graphs 2508, a drop-down menu 2510 for choosing a performance parameter to plot on a left axis of the graph section 2502, a drop-down menu 2512 for choosing a value to plot on a right axis of the graph section 2502, an updated action area 2514 for updating the graph illustrated on the graph section 2502, numerical listings of one or more performance parameters 2516 relating to the plotted graph 2502, and download action area 2518 for downloading advertisement campaign information in various formats.

To generate an illustration in the graph section 2502, a user should choose a report type 2504, an account level 2506, a type of graph 2508 and a value for either the left axis 2510 or the right axis 2512. The report type 2504 defines the type of report illustrated in the graph section 2502 such as a performance summary report, a daily summary report, a daily budgeting report, an ad campaign by name summary report, an ad group by name summary report, an advertisement by name summary report, or any other type of report defined by an advertiser or an advertisement service provider. Examples of report types are described in detail in U.S. patent application Ser. No. ______, (Attorney Docket No. 12729/136), titled “Advertiser Reporting System and Method in a Networked Database Search System”, filed on Apr. 28, 2006, the entirety of which is hereby incorporated herein by reference. The report type 2504 is further refined by the account level at which the user chooses to view the report 2506. Typically, a report can be viewed based on an advertiser account level, an advertisement campaign level, an ad group level, or any other grouping of advertisement campaign information as defined by an advertiser or an advertisement service provider.

To customize the illustration in the graph section 2502, the user may choose selector 2508 to view the report as a line graph, a bar graph, a pie chart, or any other type of graph known in the art. Further, the user may customize the illustration in the graph section 2502 by choosing a performance parameter to graph with respect to the left axis 2510 versus a period of time and choosing a performance parameter to graph with respect to the right axis 2512 versus the period of time. The performance parameter graphed on the left 2510 or right 2512 axis may be a number of impressions, clicks, CPC, a number of conversions, a conversion rate, CPA, amount spent, revenue, ROAS, or any other performance parameter provided by an advertisement service provider associated with an advertiser account, ad campaign, ad group, advertisement, or other grouping of information as defined by an advertiser or advertisement service provider.

In some embodiments, each of the GUIs described above with respect to FIGS. 3-31 are dynamic and may be customizable. For example, users may interact with the ad campaign management system to turn on and off certain options associated with their account. As a result, the ad campaign management system may display a customized GUI to the user that removes information associated with options at the ad campaign management system that have been disabled. For example, if a user turns off an optimization function at the ad campaign management system, the ad campaign management system may remove all performance parameters or options from the GUI presented to that user relating to optimization.

In other embodiments, the ad campaign management system may additionally provide the ability for a user to define which performance parameters are displayed to the user. For example, a user may be able to choose which performance parameters relating to an account the ad campaign management system presents to the user in a GUI or the user may be able to choose an order of how the different types of performance parameters are presented to the user. A customizable GUI allows the ad campaign management system to provide users with information that is most relevant to the user as defined by the user.

FIG. 32 is a block diagram of one embodiment of a system 3200 for facilitating display of advertisement campaign information. The system 3200 typically comprises an advertisement service provider (advertisement campaign management system) comprising one or more servers 3202 in communications with a user device 3204 over a network 3206. Generally, an advertisement service provider 3202 organizes advertisement campaign information into an account hierarchy, as described above, according to a user account, one or more ad campaigns associated with the user account, one or more ad groups associated with the ad campaigns, and keyword and advertisement information associated with the ad groups. After organizing the advertisement campaign information, the advertisement service provider 3202 sends at least a portion of the advertisement campaign information to the user 3204 for display based at least in part on the one or more ad groups.

Each server of the advertisement service provider 3202 may comprise a processor 3208, a network interface 3210 in communication with the processor 3208, and a memory unit 3212 in communication with the processor 3208. Typically, the memory unit 3212 stores at least advertisement campaign information. Advertisement campaign information may comprise information relating to relationships between a user account, ad campaigns, and ad groups; performance parameters associated with a user account, ad campaigns, and ad groups; or advertisements and keywords associated with a user account, ad campaigns, and ad groups.

The processor 3208 is typically operative to perform one or more operations to organize the advertisement campaign information stored in the memory unit 3212 into one or more ad groups as defined by an advertiser. As described above, an ad group may be thought of as a conceptual compartment or container that includes advertisements and parameters for advertisements that are handled in a similar manner.

After organizing the advertisement campaign information into one or more ad groups, the advertisement service provider 3202 may send at least a portion of the advertisement campaign information to the user device 3204 via the network interface 3210 for display based at least in part on the one or more ad groups. In one embodiment, the advertisement service provider 3202 sends one or more hypertext pages that comprise a graphical user interface such as those in FIGS. 3-31 when the one or more hypertext pages are executed in an internet-browser, stand-alone application, or any other device known in the art.

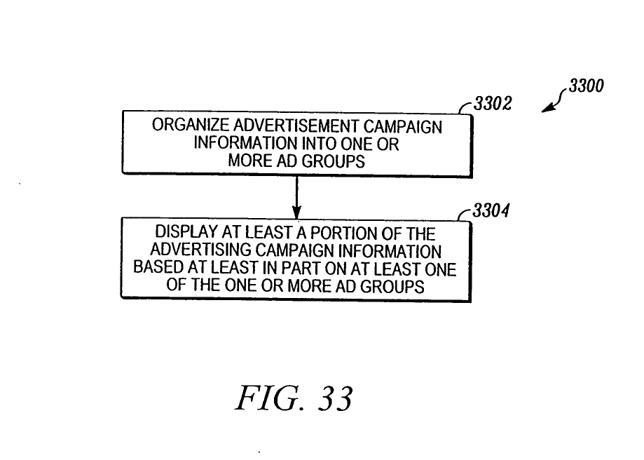

FIG. 33 is a flow diagram of one embodiment of a method for facilitating display of advertisement campaign information. The method 3300 begins with the advertisement service provider organizing advertisement campaign information into one or more ad groups 3302. The advertisement provider may organize the advertisement campaign information into one or more ad groups as defined by advertiser based on a search tactic, a performance parameter of the advertisement campaign information, or any other parameter provided by the advertisement service provider that relates to an ad group.

The advertisement service provider then displays advertisement campaign information based at least in part on the one or more ad groups 3304 to a user. The advertisement campaign information may be displayed in a GUI, such as in FIGS. 3-31, running in an internet browser on a user device, displayed in a stand-alone application running on a user device or displayed on any other device known in the art.

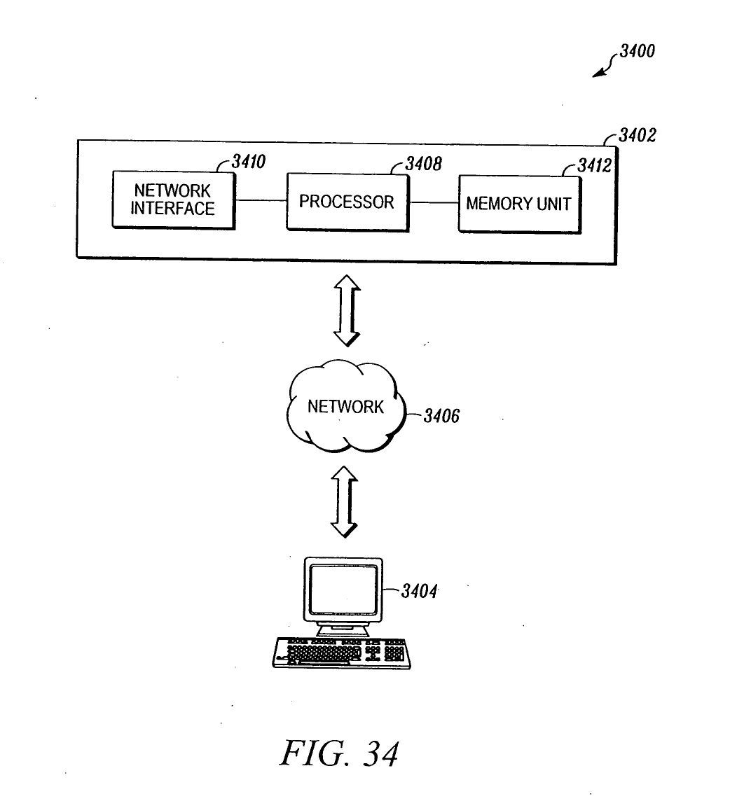

FIG. 34 is a block diagram of one embodiment of a system for managing advertisement campaign information. Similar to the system of FIG. 32, the system typically comprises an advertisement service provider (advertisement campaign management system) comprising one or more servers 3402 in communication with a user device 3404 over a network 3406. As explained above, the advertisement service provider may comprise a processor 3408, a network interface 3410 in communication with the processor 3408, and a memory unit 3412 in communication with the processor 3408.

Generally, the advertisement service provider 3402 executes one or more programs running on the processor 3408 to organize advertisement campaign information stored in the memory unit 3412 into one or more ad groups as defined by an advertiser.

In one embodiment, the advertisement service provider 3402 sends at least a portion of the advertisement campaign information organized into one or more ad groups over the network 3406, via the network interface 3410, to the user device 3404. The user device 3404, using an internet browser, stand-alone application, or any other type of application known in the art, displays at least a portion of the received advertisement campaign information in a user interface (“UI”), such as in FIGS. 3-31, to a user and is operative to allow the user to modify advertisement campaign information based at least in part on at least one of the one or more ad groups. For example, the user may modify a maximum CPC associated with an ad group; add or delete a keyword associated with an ad group; add or delete advertisements associated with an ad group; modify a business objective associated with an ad group; modify a search tactic associated with an ad group; modify budget constraints associated with an ad group; or modify any other performance parameter associated with an ad group.

In another embodiment, the user device 3402 sends at a least a portion of the advertisement campaign information organized into one or more ad groups over the network 3406, via an application program interface (“API”) of the network interface 3410, to the user device 3404. The user device 3304, using an application operative to communicate with the API of the advertisement service provider 3402, receives the advertisement campaign information and is operative to modify advertisement campaign information based at least in part on at least one of the one or more ad groups as described above.

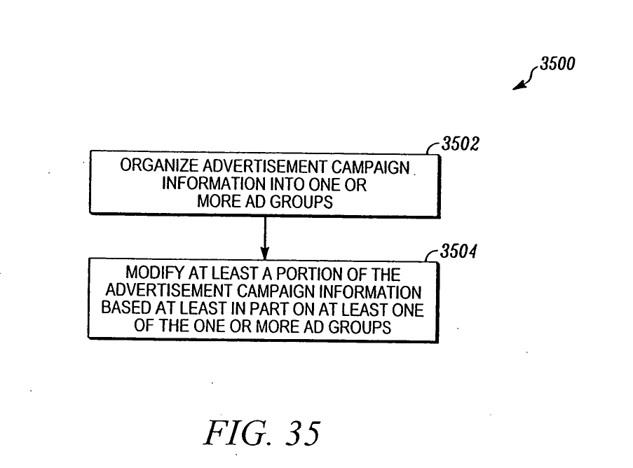

FIG. 35 is a flow diagram of one embodiment of a method for managing advertisement campaign information. The method 3500 begins with the advertisement service provider organizing advertisement campaign information into one or more ad groups 3502. The advertisement campaign information is then modified based at least in part on the one or more ad groups 2904 as described above.

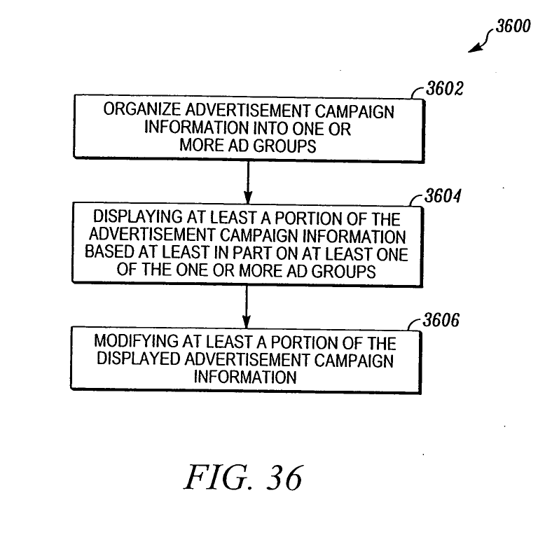

FIG. 36 is a flow diagram of another embodiment of a method for managing advertisement campaign information. The method 3600 begins with the advertisement service provider organizing advertisement campaign information into one or more ad groups 3602. At least a portion of the advertisement campaign information is displayed 3604, such as in FIGS. 3-31, based at least in part on at least one of the one or more ad groups, and at least a portion of the displayed advertisement campaign information is modified 3506 as described above.

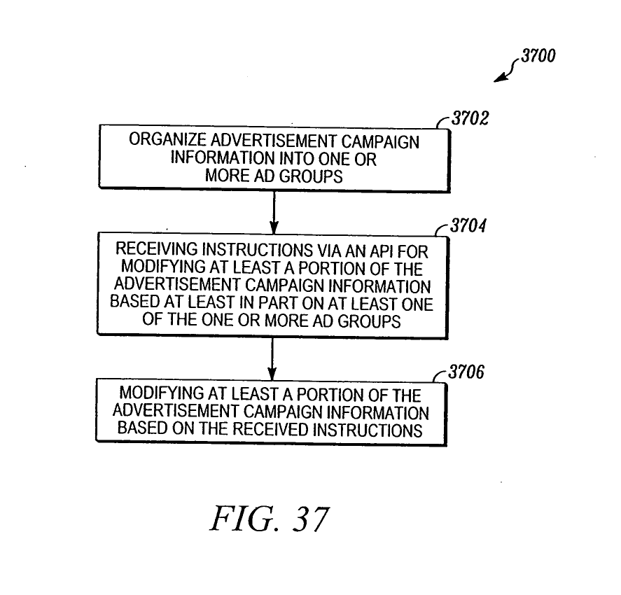

FIG. 37 is a flow chart of another embodiment of a method for managing advertisement campaign information. The method 3700 begins with the advertisement service provider organizing advertisement campaign information into one or more ad groups 3702. Instructions are received via an application program interface (“API”) for modifying at least a portion of the advertisement campaign information based at least in part on at least one of the one or more ad groups 3704 and at least a portion of the advertisement campaign information is modified based on the received instructions 3706.

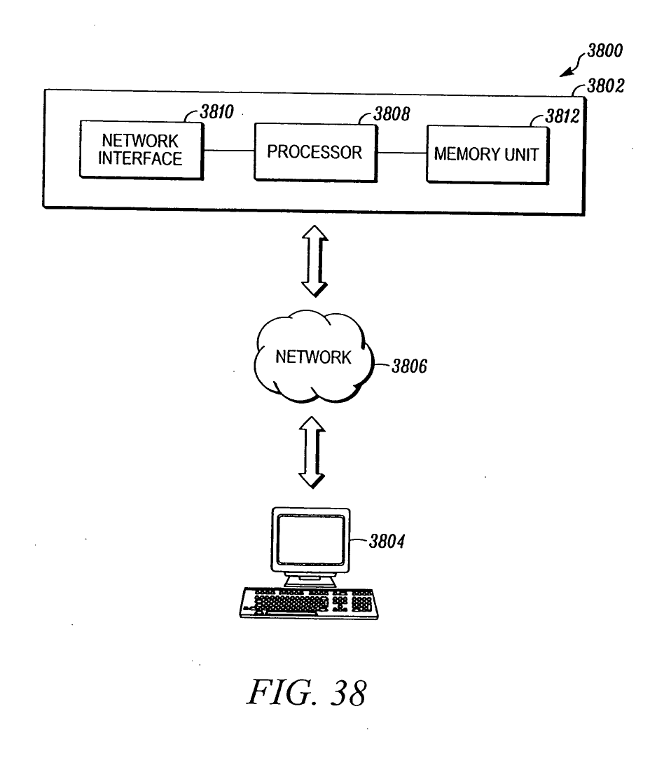

FIG. 38 a block diagram of one embodiment of a system for optimizing advertisement campaign information. Similar to the system of FIGS. 32 and 34, the system typically comprises an advertisement service provider (advertisement campaign management system) comprising one or more servers 3802 in communication with a user device 3804 over a network 3806. As explained above, the advertisement service provider may comprise a processor 3808, a network interface 3810 in communication with the processor 3808, and a memory unit 3812 in communication with the processor 3808.

Generally, the advertisement service provider 3802 executes one or more programs running on the processor 3808 to organize advertisement campaign information stored in the memory unit 3812 into one or more ad groups as defined by an advertiser.

In one embodiment, the advertisement service provider sends at least a portion of the advertisement campaign information organized into one or more ad groups over the network 3806, via the network interface 3810, to the user device 3804. The user device 3804, using an internet browser, stand-alone application, or any other type of application known in the art, displays at least a portion of the received advertisement campaign information in a user interface (“UI”), such as in FIGS. 3-31, to a user and is operative to allow the user to optimize performance of the advertisement campaign information based at least in part on at least one of the one or more ad groups. For example, the user may dynamically create estimates of performance parameters based on potential CPC values or potential business objective setting, and change actual performance parameter or business objective setting based on the estimates for an ad group.

In another embodiment, the user device 3802 sends at a least a portion of the advertisement campaign information organized into one or more ad groups over the network 3806, via an application program interface (“API”) of the network interface 3810, to the user device 3804. The user device 3804, using an application operative to communicate with the API of the advertisement service provider 3802, receives the advertisement campaign information and is operative to optimize performance of the advertisement campaign information based at least in part on at least one of the one or more ad groups as described above.

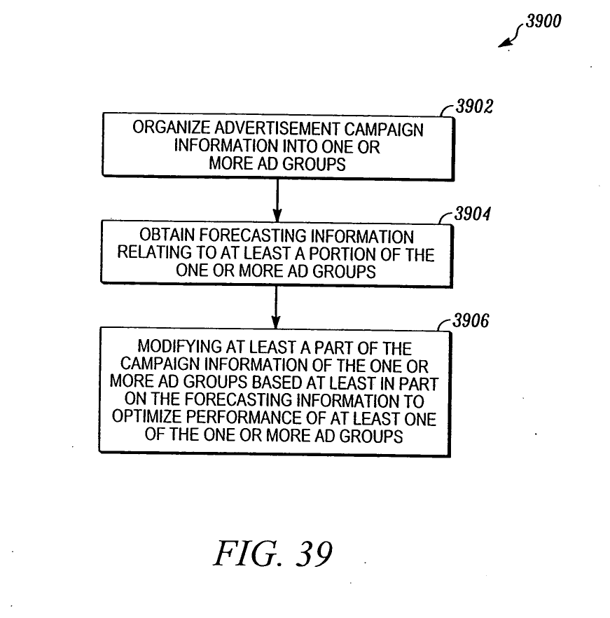

FIG. 39 is a flow diagram of one embodiment of a method for optimizing advertisement campaign information. The method 3900 begins with the advertisement service provider organizing advertisement campaign information into one or more ad groups 3902. The advertisement service provider obtains forecasting information relating to at least a portion of the one or more ad groups 3904, and the advertisement campaign information is modified based at least in part on the forecasting information to optimize performance of at least one of the one or more ad groups 3906 as described above.

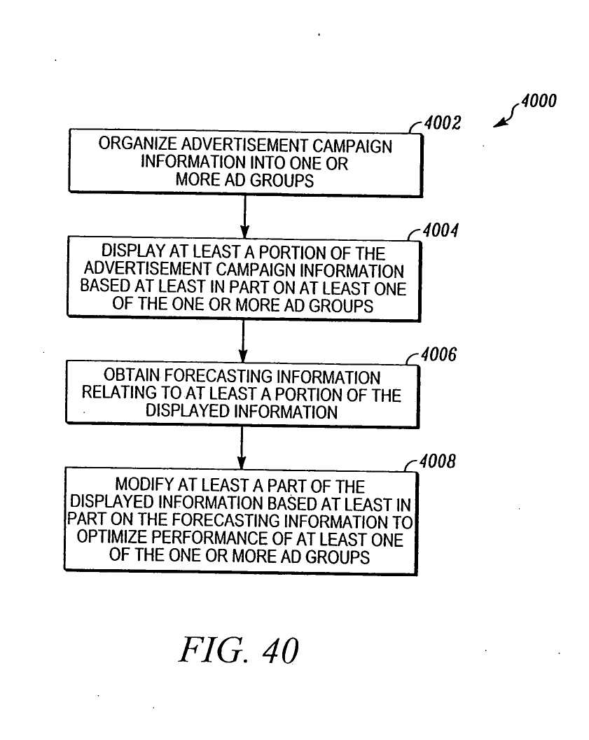

FIG. 40 is a flow diagram of another embodiment of a method for optimizing advertisement campaign information. The method 4000 begins with the advertisement service provider organizing advertisement campaign information into one or more ad groups 4002. At least a portion of the advertisement campaign information is displayed 4004 based at least in part on at least one of the one or more ad groups, and the advertisement service provider obtains forecasting information relating to at least a portion of the displayed information 4006. The displayed information is then modified based at least in part on the forecasting information to optimize performance of at least one of the one or more ad groups 4008 as described above.

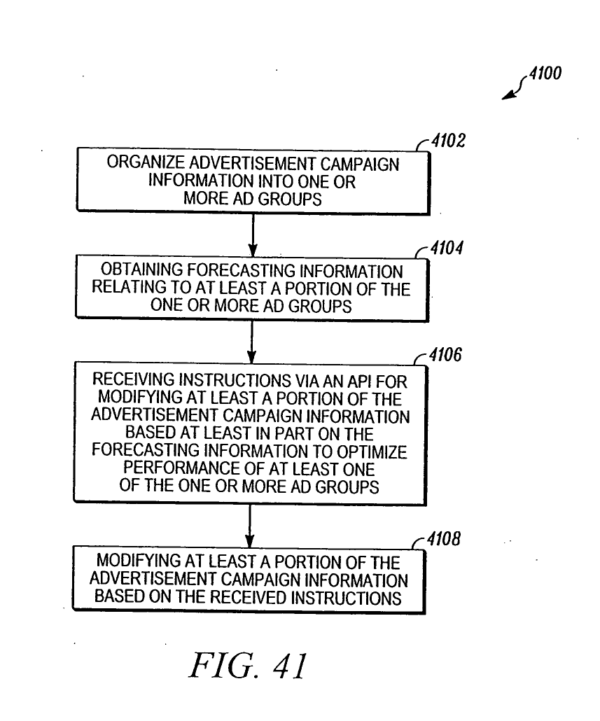

FIG. 41 is a flow chart of another embodiment of a method for optimizing advertisement campaign information. The method 4100 begins with the advertisement service provider organizing advertisement campaign information into one or more ad groups 4102. Forecasting information relating to at least a portion of the one or more ad groups is obtained 4104 and instructions are received via an application program interface (“API”) for modifying at least a portion of the advertisement campaign information based at least in part on the forecasting information to optimize performance of at least one of the one or more ad groups 4106. At least a portion of the advertisement campaign information is then modified based on the received instructions 4108.

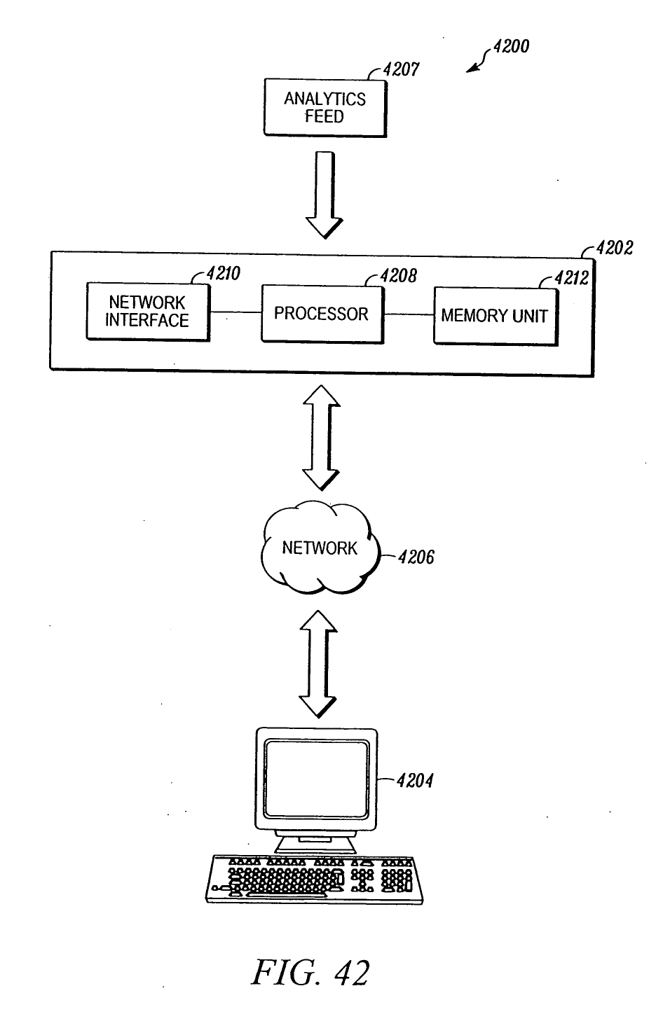

FIG. 42 is a block diagram of one embodiment of a system for reporting advertisement campaign information. Similar to the system of FIGS. 32, 34 and 38, the system typically comprises an advertisement service provider (advertisement campaign management system) comprising one or more servers 4202 in communication with a user device 4204 over a network 4206. However, the system for reporting advertisement campaign information additionally comprises an analytics feed 4207 provided by the advertisement campaign management system or another third-party. As explained above, the advertisement service provider may comprise a processor 4208, a network interface 4210 in communication with the processor 4208, and a memory unit 4212 in communication with the processor 4208.

Generally, the advertisement service provider 4202 executes one or more programs running on the processor 4208 to collect advertisement campaign information from components within the advertisement service provider and at least one analytics feed 4207, and to store the advertisement campaign information in the memory unit 4212. The advertisement service provider 4202 executes one or more additional programs running on the processor 4208 to organize the advertisement campaign information stored in the memory unit 4212 into one or more ad groups.

In one embodiment, the advertisement service provider 4202 receives instructions from the user device 4204, via the network interface 4210, regarding how to customize a report based at least in part on the one or more ad groups. In response, the advertisement service provider 4202 executes one or more programs running on the processor 4208 to generate a customized report based on the received instructions from the user device 4204, and sends at least a portion of the customized report over the network 4206, via the network interface 4210, to the user device 4204. The user device, using an internet browser, stand-alone application, or any other type of application known in the art, displays at least a portion of the received customized report in a user interface (“UI”), such as in FIGS. 3-31, based at least in part on at least one of the one more ad groups.

In another embodiment, the advertisement service provider 4202 receives instructions from the user device 4204, via an application program interface (“API”) of the network interface 4210, regarding how to customize a report based at least in part on the one or more ad groups. In response, the advertisement service provider 4202 executes one or more programs running on the processor 4208 to generate a customized report based on the received instructions from the user device 4204, and sends at least a portion of the customized report over the network 4206, via the API of the network interface 4210, to user device 4204. The user device, using an application operative to communication with the API of the network interface 4210 of the advertisement service provider 4202 receives the portion of the customized report and display at least a portion of the received customized report based at least in part on at least one of the one or more ad groups.

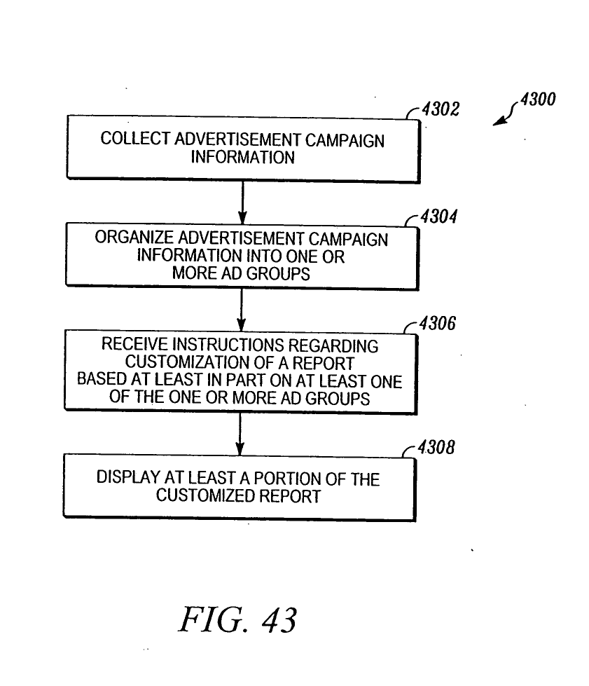

FIG. 43 is a flow diagram of one embodiment of a method for reporting advertisement campaign information. The method 4300 begins with the advertisement service provider (advertisement campaign management system) collecting advertisement campaign information from components within the advertisement service provider and at least one analytics feed 4302. The advertisement service provider organizes the advertisement campaign information into one or more ad groups 4304 and receives instructions regarding customization of a report based at least in part on at least one of the one or more ad groups 4306. The advertisement service provider generates the report based on the received instructions and displays at least a portion of the customized report based at least in part on at least one of the one or more ad groups 4008 as described above.

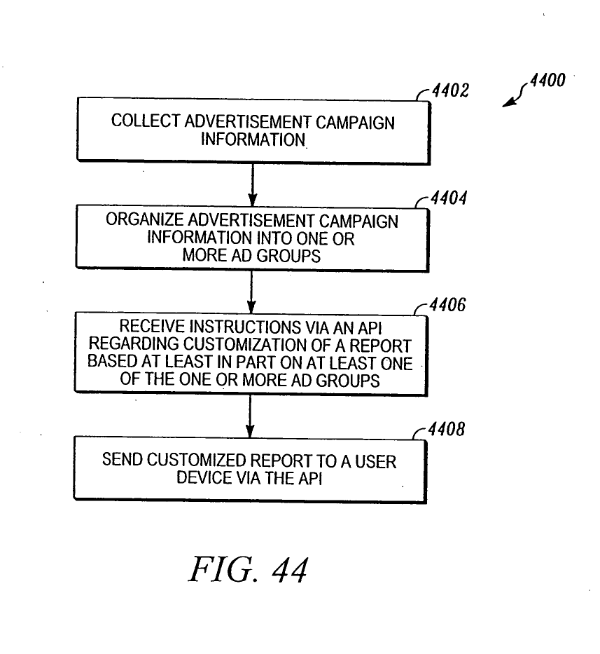

FIG. 44 is a flow chart of another embodiment of a method for reporting advertisement campaign information. The method 4400 begins with the advertisement service provider (advertisement campaign management system) collecting advertisement campaign information from components within the advertisement service provider and at least one analytics feed 4402. The advertisement service provider organizes the advertisement campaign information into one or more ad groups 4404 and instructions are received via an application program interface (“API”) regarding customization of a report based at least in part on at least one of the one or more ad groups 4406. A customized report is then sent to a user device via the API 4408.

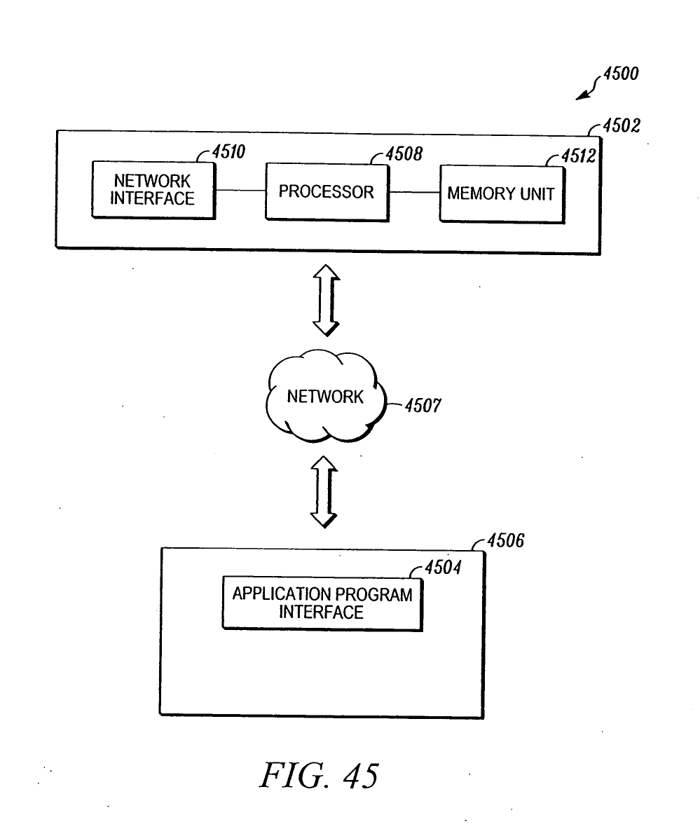

FIG. 45 is a block diagram of one embodiment of a system 4502 for interacting with an application program interface (“API”) 4504 of an advertisement campaign management system 4506 over a network 4507. Typically, the system 4502 comprises a processor 4508, a network interface 4510 in communication with the processor 4508, and a memory unit 4512 in communication with the processor 4508.

Generally, the processor 4508 is operative to execute one or more instructions stored in the memory unit 4512 to communicate via the network interface 4510 with the API 4504 of the advertisement campaign management system 4506. In one embodiment, the processor 4508 may execute instructions to communicate with the API 4504 to send commands defining how to organize advertisement campaign information into one or more ad groups. In another embodiment, the processor 4508 may execute instructions to communicate with the API 4504 to send instructions to the advertisement campaign management system 4506 to modify advertisement campaign information organized into one or more ad groups based at least in part on at least one of the one or more ad groups. In yet another embodiment, the processor 4508 may execute instructions to communicate with the API 4504 to receive forecasting information related to advertisement campaign information organized into one or more ad groups and send instructions to the advertisement campaign management system 4506 to modify at least one ad group based on the forecasting information to optimize performance of one or more ad groups. In yet another embodiment, the processor 4508 may execute instructions to communicate with the API 4504 to send information to the advertisement campaign management system 4506 regarding customization of a report comprising advertisement campaign information organized into one or more ad groups and receive the customized report via the API 4504 of the advertisement campaign management system 4506.

It will be appreciated that the disclosed advertisement campaign management system as described with reference to FIGS. 1 and 2, the graphical user interfaces as described with reference to FIGS. 3-31, and the systems and methods as described with reference to FIGS. 32-45 provide user interfaces and application program interfaces to an advertisement campaign system that provides the ability to flexibly, dynamically, and efficiently manage large groups of advertisements. As opposed to traditional user interfaces and application program interfaces that only provides the ability to manage advertisement campaign information at a user account level or an individual advertisement level, users many now manage advertisement campaign information at an account level defined by the user. Users are given the ability to define their own groups of advertisement campaign information (an ad group) for advertisements that will be handled by the advertisement campaign management system in a similar manner. For example, users may group advertisements by a search tactic, performance parameter, demographic of user, family of products, or almost any other parameter desired by the user. Allowing users to define their own ad groups allows the advertisement campaign management system to provide more useful information to the user thereby allowing the user to display, manage, optimize, or view reports on, advertisement campaign information in a manner most relevant to an individual advertiser.

It is therefore intended that the foregoing detailed description be regarded as illustrative rather than limiting, and that it be understood that it is the following claims, including all equivalents, that are intended to define the spirit and scope of this invention.

1. A method for facilitating display of advertisement campaign information, comprising:
organizing advertisement campaign information into one or more ad groups; and
sending at least a portion of the advertisement campaign information to a user interface for display based at least in part on at least one of the one or more ad groups.

2. The method of claim 1, wherein at least one of the one or more ad groups comprises advertiser customized and defined groups of advertisement campaign data.

3. The method of claim 1, wherein based at least in part on at least one of the one or more ad groups comprises arranged at least in part on at least one of the one or more ad groups.

4. The method of claim 1, wherein at least one of the one or more ad groups comprises advertisements and parameters for advertisements that are handled by an advertisement campaign management system in a similar manner.

5. The method of claim 1, wherein at least one of the one or more ad groups comprises advertisements and parameters for advertisements targeted to a demographic group.

6. The method of claim 5, wherein the demographic group comprises a sex of a user performing an internet search.

7. The method of claim 5, wherein the demographic group comprises a geographic location of a user performing an internet search.

8. The method of claim 5, wherein the demographic group comprises an income level of a user performing an internet search.

9. The method of claim 5, wherein the demographic group comprises an age of a user performing an internet search.

10. The method of claim 1, wherein at least one of the one or more ad groups comprises advertisements and parameters for advertisements targeted to a family of products.

11. The method of claim 1, wherein at least one of the one or more ad groups comprises advertisements and parameters for advertisements comprising the same search tactic.

12. The method of claim 11, wherein the search tactic comprises sponsored search.

13. The method of claim 11, wherein the search tactic comprises content match.

14. The method of claim 1, wherein sending at least a portion of the advertisement campaign information to a user interface for display based at least in part on at least one of the one or more ad groups comprises:
sending a summary of an ad group of the one or more ad groups comprising a plurality of parameters associated with the displayed ad group to the user.

15. The method of claim 1, wherein sending at least a portion of the advertisement campaign information to a user interface for display based at least in part on at least one of the one or more ad groups comprises:
sending a graphical illustration of a parameter associated with one of the one or more ad groups over a period of time to the user.

16. The method of claim 1, wherein organizing advertisement campaign information into one or more ad groups comprises:
receiving commands from a user defining how to organize the advertisement campaign information into one or more ad groups.

17. The method of claim 1, wherein the at least a portion of the advertisement campaign information is displayed in a graphical user interface to a user.

18. The method of claim 17, wherein the graphical user interface is displayed in an internet browser.

19. The method of claim 17, wherein the graphical user interface is displayed in a stand-alone application.

20. A system for facilitating display of advertisement campaign information, comprising:
means for organizing advertisement campaign information into one or more ad groups; and
means for sending at least a portion of the advertisement campaign information to a user interface operative to display the at least a portion of the advertisement campaign information based at least in part on at least one of the one or more ad groups.

21. The system of claim 20, wherein at least one of the one or more ad groups comprises advertiser customized and defined groups of advertisement campaign information.

22. The system of claim 20, wherein based at least in part on at least one of the one or more ad groups comprises arranged at least in part on at least one of the one or more ad groups.

23. The system of claim 20, wherein at least one of the one or more ad groups comprises advertisements and parameters for advertisements that are handled by an advertisement campaign management system in a similar manner.

24. A computer-readable storage medium comprising a set of instructions for facilitating display of advertisement campaign information, the set of instructions to direct a computer system to perform acts of:
organizing advertisement campaign information into one or more ad groups; and
sending at least a portion of the advertisement campaign information to a user interface for display based at least in part on at least one of the one or more ad groups.

25. The computer-readable storage medium of claim 24, wherein at least one of the one or more ad groups comprises advertiser customized and defined groups of advertisement campaign information.

26. The computer-readable storage medium of claim 24, wherein at least one of the one or more ad groups comprises advertisements and parameters for advertisements that are handled by an advertisement campaign management system in a similar manner.

27. The computer-readable storage medium of claim 24, wherein sending at least a portion of the advertisement campaign information to a user interface for display based at least in part on at least one of the one or more ad groups comprises:
sending a summary of an ad group of the one or more ad groups comprising a plurality of parameters associated with the displayed ad group to the user; and
sending a graphical illustration of a parameter associated with one of the one or more ad groups over a period of time to the user.

28. The computer-readable storage medium of claim 24, wherein organizing advertisement campaign information into one or more ad groups comprises:
receiving commands from a user defining how to organize the advertisement campaign information into one or more ad groups.

29. The computer-readable storage medium of claim 24, wherein the at least a portion of the advertisement campaign information is displayed in a graphical user interface to a user.

30. The computer-readable storage medium of claim 29, wherein the graphical user interface is displayed in an internet browser.

31. The computer-readable storage medium of claim 29, wherein the graphical user interface is displayed in a stand-alone application.

32. An application program interface (“API”) of an advertisement campaign management system, the API operative to facilitate communications over a network between the advertisement campaign management system and an application running on a user device, wherein the API receives a request from the application running on the user device to access advertisement campaign information organized into one or more ad groups stored at the advertisement campaign management system.
